(19) United States
(12) Patent Application Publication
(10) Pub. No.: US 2025/0355842 A1
(43) Pub. Date: Nov. 20, 2025

(54) TRANSFORMING A LARGE-SCALE MULTI-USER APPLICATION PROVIDER'S APPLICATION DATA MANAGEMENT WITH A UNIFIED GRAPH INTERFACE AND APPLICATION-LOGIC HOSTING

(71) Applicant: Microsoft Technology Licensing, LLC, Redmond, WA (US)

(72) Inventors: Siddharth Agarwal, Los Altos, CA (US); Parinkumar Dipakkumar Shah, Milpitas, CA (US); Ganesan Venkatasubramanian, Cupertino, CA (US); Roman Inozemtsev, Redwood City, CA (US); Jean-Baptiste Chery, Walnut Creek, CA (US); Banu Muthukumar, San Jose, CA (US); Siddharth Shah, San Francisco, CA (US)

(21) Appl. No.: 18/667,268

(22) Filed: May 17, 2024

(51) Int. Cl. G06F 16/21; G06F 16/215; G06F 16/2453

(52) U.S. Cl. CPC G06F 16/213; G06F 16/215; G06F 16/24544

(57) ABSTRACT

There is difficulty in managing and querying highly relational data in large-scale multi-user applications. The interconnected nature of the data entities poses challenges in efficiently storing, retrieving, and manipulating the data. Disclosed are solutions that involve establishing a graph serving layer within the API schema of the application. This layer defines a structured vocabulary for describing the data entities and their interrelations. The data is stored in accordance with this structure, and a global look-aside index is generated to enable efficient querying. The index supports filter and join operations, allowing for targeted retrieval of data based on specific criteria. Queries are received via the API schema, and the relevant data is retrieved using the global look-aside index. The retrieved data is then returned to the requesting application or user via the API schema.

### BACKGROUND

A provider of a large-scale multi-user application faces challenges managing highly relational application data. The application data may encompass application data entities such as, for example, members, shares, jobs, organizations, and member settings that are defined using structured application data schemas in a data modeling language, such as, for example, the APACHE AVRO Interface Definition Language (IDL) or the like. The structured schemas specify the data format and structure, make these entities accessible and manipulable through a Representational State Transfer (REST)-ful service framework or the like (e.g., Simple Object Access Protocol (SOAP), GraphQL, gRPC, Open Data Protocol (OData), or WebSocket). REST and other like architectural styles for designing multi-user applications are useful in enabling the creation, discovery, and management of structured application data entities over a network, offering a standardized way to access and manipulate application data across different services and applications within a provider's architecture.

To navigate and operate within this ecosystem, application developers of the provider may need to interact with a complex application programming interface (API) and technology landscape that may include both standard and bespoke elements. This complexity may include the need to work within the constraints of the existing data storage and management systems implementing the application, which might be organized in silos, complicating the task of querying and integrating data across different domains. The siloed nature of data management and the bespoke APIs can impose a burdensome overhead in the development process.

There is a need for tools and platforms that can aid in the discovery, retrieval, and manipulation of data across these complex systems, as well as frameworks or services that enable the reuse and sharing of connective logic to reduce fragmentation and improve efficiency in the product tech stack.

### BRIEF DESCRIPTION OF THE DRAWINGS

The following detailed description of certain embodiments of the invention are understood by reference to the following figures:

FIG. 1 illustrates a system implementing a method for managing highly relational application data in a large-scale multi-user application, according to an embodiment.

FIG. 2 illustrates an extension of the system and method of FIG. 1 that focuses on the creation and management of additional data entities within the large-scale multi-user application, according to an embodiment.

FIG. 3 illustrates an embodiment of the system and method of FIG. 1 that focuses on the specific functionalities and benefits provided by the global look-aside index, according to an embodiment.

FIG. 4 illustrates an extension of the system and method of FIG. 1 that focuses on how the graph serving layer and the global look-aside index work together to efficiently query and manipulate data entities while preserving the integrity and encapsulation of the microservices that host these entities, according to an embodiment.

FIG. 5 illustrates an extension of the system and method of FIG. 1 highlighting how the global look-aside index operates at an application-level schema abstraction, maintains consistency with the graph serving layer, and executes join operations to improve query performance and simplify client-side operations, according to an embodiment.

FIG. 6 illustrates an extension of the system and the method of FIG. 1 that focuses on the process of creating and integrating additional application data entities into the graph serving layer using an entity definition interface, according to an embodiment.

FIG. 7 illustrates a method that focuses on simplifying the onboarding process for additional application data entities by automating the generation of database schemas, APIs, and provisioning of databases, according to an embodiment.

FIG. 8 illustrates a method that focuses on the process of creating an additional application data entity and seamlessly integrating it into the graph serving layer, according to an embodiment.

FIG. 9 illustrates a method that focuses on the process of receiving and executing complex queries that involve filter operations, join operations, and search operations on the plurality of data entities, according to an embodiment.

FIG. 10 illustrates a method that focuses on the process of evolving existing application data entities by modifying their schemas, adding additional properties and relationships, and automatically updating the structured vocabulary and global look-aside index, according to an embodiment.

FIG. 11 illustrates a method for managing highly relational application data in a large-scale multi-user application, according to an embodiment.

FIG. 12 illustrates a method for updating a global look-aside index in a multi-user application by extracting a primary key from a change capture stream record, requesting the updated record from a source of truth microservice, and updating the index with the received record in the API schema format, thereby maintaining consistency without requiring custom transformation logic, according to an embodiment.

FIG. 13 illustrates an example multi-user application system in which the techniques disclosed herein for transforming a large-scale multi-user application provider's application data management with a unified graph interface and application-logic hosting are implemented.

FIG. 14 illustrates an example programmable electronic device that processes and manipulates data to perform the techniques disclosed herein for transforming a large-scale multi-user application provider's application data management with a unified graph interface and application-logic hosting.

### DETAILED DESCRIPTION

Systems, methods, non-transitory computer-readable media, and graphical user interfaces (generally referred to herein as “the techniques”) are disclosed for transforming a large-scale multi-user application provider's application data management with a unified graph interface and application-logic hosting.

### General Overview

The techniques address a series of technical challenges faced by the provider of the large-scale multi-user application due to the highly relational nature of the application's data when managed as isolated data entities. This siloed architecture places significant demands on the provider's technology stack, especially when it comes to querying datasets that are complexly interlinked. For example, data entities, defined by their structured schemas, addressable records, and availability through REST resources or other like frameworks, encompass a wide range of persistent identities such as people, customers, contracts, and more. However, the siloed management of these entities complicates the process for the application developers who must engage with a diverse and sometimes custom-built API and technology ecosystem. This complexity arises not only in the introduction, discovery, retrieval, and manipulation of data and entities within provider's architecture but also in dealing with entities across different segments of the organization.

The bespoke nature of the existing system forces developers to create and maintain custom logic for data connectivity, which ends up being locked within specific online services, whether they are pre-existing or newly developed for specific purposes. This approach not only limits the opportunities for sharing and re-utilizing connective logic but also contributes to further fragmentation within the provider's product stack. Additionally, the necessity to collaborate with a wide range of supporting or partner teams introduces another layer of complexity, often manifesting as support-related overhead, challenges in alignment, or other blockers that can slow down or complicate the development and integration process. This multi-faceted challenge highlights the need for a more integrated and flexible approach to managing relational data within the multi-user application to streamline development processes and foster more efficient and collaborative tech environments.

The techniques disclosed herein address these technical challenges faced by the provider in managing its highly relational data by introducing a more integrated and efficient architectural approach. This approach is centered around creating a standard graph-like interface and an application-logic hosting layer, aiming to streamline the development process, improve data accessibility, and enhance the management of data entities and their relationships.

In an embodiment of the techniques, a graph serving layer is established in an application programming interface (API) schema. By establishing the graph serving layer in the API schema, the techniques offer a concrete vocabulary that accurately describes entities and their interrelations within the provider's multi-user application ecosystem. This structure facilitates navigation, discovery, and access to a comprehensive set of data entities, eliminating the costs and complexities associated with managing untyped schemas and inconsistent data sources. A component of this interface is a global look-aside index that enables rich queries, including filter and join operations, thereby streamlining the retrieval and integration of data across different entities.

In an embodiment, the techniques encompass a managed online service component offering a robust platform for hosting data entities, making it significantly easier and faster to introduce new entities into the ecosystem. The managed online service component simplifies the implementation of application logic for filtering through collections of entities based on specific rulesets. This simplification reduces or eliminates the need for constructing purpose-built materialized views and Create-Read-Update-Delete (CRUD) services for individual projects, thereby lowering development overhead. The managed online service component dramatically reduces the time required to add additional application data entities to the provider's application ecosystem, targeting a turnaround of less than 24 hours. This efficiency gain is useful for supporting dynamic application needs and accelerating the pace of innovation within the application. By providing a managed solution for hosting new entities on the graph, the techniques ensure that developers can easily integrate and manage data entities without the burden of dealing with underlying infrastructure complexities.

Together, the global look-aside index and new entity hosting solution consolidate the provider's fragmented data management practices into a cohesive, graph-based architecture that enhances the case of use, querying capabilities, and overall efficiency of data operations. The techniques not only alleviate the current challenges faced by application developers but also foster a more agile and collaborative development environment, positioning the provider to better leverage its rich datasets for competitive advantage.

### General Overview-Global Look-Aside-Index

In an embodiment, the global look-aside-index addresses technical challenges within the provider's conventional data management strategy, stemming from a conflict between maintaining isolated, microservice-based data entities and the need for robust relational querying capabilities across these services. The provider's conventional data architecture can be characterized by a graph of interconnected data entities such as members, shares, jobs, organizations, and member settings, which reflect complex relationships consequent of the provider's operations. For example, members working within an organization or job postings by a member for an organization illustrate the relational nature of these entities.

The conventional technical stack utilized by the provider for building these data entities includes an interface via Representational State Transfer (REST) resources. These services offer standard Create-Read-Update-Delete (CRUD) operations, access through non-primary keys via finders, and sometimes custom behaviors through action methods. The architecture conventionally involves one microservice per data domain, ensuring a focused approach to managing specific data entities.

The conventional technical stack utilized by the provider also includes an underlying persistence layer. This layer is supported either by distributed Key-Value (KV) stores or relational database management systems (RDBMSs). The choice of storage technology influences the scalability and accessibility of the data.

The conventional technical stack utilized by the provider also incorporates service and database encapsulation where each microservice controls access to its specific database instance(s), which may contain one or more tables. This encapsulation provides several benefits, such as API/database schema separation, the ability to independently scale services, and a singular access point for enforcing authorization and domain-specific policies.

However, a significant drawback of the provider's conventional technical stack is the siloing of datasets, which impedes the ability to perform rich querying across data entities due to their storage in encapsulated siloed data stores such as, for example, separate KV stores or disparate RDBMSs. The relational nature of the data demands capabilities that KV stores can't efficiently provide, such as joining or filtering across datasets. A possible workaround involves creating pre-materialized views or indexes for each specific query need. This workaround, however, is far from ideal and represents a considerable effort compared to the declarative querying possible in relational database management systems (RDBMS).

The challenge lies in reconciling the desire for microservice independence and encapsulation with the need for cross-service relational data querying. In conventional monolithic systems, Object-Relational Mapping (ORM) solutions bridge the gap between object models and database tables, enabling rich query capabilities through SQL executed against a single database. However, the distributed nature of microservices, each with its isolated database, complicates achieving similar relational querying capabilities.

Alternatives exist for specific use cases, but these often come with their limitations, indicating the need for a novel approach to enable relational querying across microservices without compromising the autonomy and scalability benefits that the microservice architecture provides. This challenge underscores the necessity for a sophisticated solution that can offer the best of both worlds: the isolation and scalability of microservices and the relational querying capabilities of traditional RDBMS, thereby addressing the core conflict in provider's online data services stack.

The global look-aside index addresses technical challenges within the provider's conventional data management strategy by reconciling the conflict between the benefits of microservice architecture—specifically, the isolation and encapsulation of data services—and the need for complex relational querying across these services. The index is “global” because it aggregates records and relationships from multiple data entities across the provider, thus overcoming the limitation of siloed datasets. It's “online” as it supports real-time querying capabilities, allowing for immediate access and manipulation of data. The term “look-aside” indicates that the index operates in parallel (“next to”) the source of truth (SoT) entities, rather than directly within them, providing a layer that enriches the querying capabilities without intruding on the primary data storage or its operations. The “index” aspect facilitates efficient lookups by non-primary keys, attribute filters, and edge traversal, enhancing performance and flexibility in data querying.

Unlike conventional solutions which attempt to integrate transformation and application logic into the query execution phase through User Defined Functions (UDFs), the global look-aside-index approach of the techniques allows application logic to remain within the respective REST services. This distinction ensures that the core functionalities and policies managed by each service are not duplicated or relocated, maintaining the integrity and encapsulation of each microservice.

Unlike conventional technologies that focus on per-query index generation and operate at the storage level schema rather than the application-level schema, the global look-aside-index operates at a higher abstraction level, closer to how data is utilized by applications, thus offering a more accessible and flexible querying capability. Another technical benefit is that the global look-aside-index maintains consistency by working alongside existing schemas without introducing additional layers of complexity. Yet another technical benefit is that the global look-aside-index pushes joins to the global index level, improving performance and simplifying client-side operations, rather than relying exclusively or extensively on client-side “hops” or joins, which can introduce performance and complexity issues.

The global-look aside index addresses a specific challenge within the context of the problems faced by the provider of the large-scale multi-user application. As mentioned above, the global look-aside index is a component of the integrated and efficient architectural approach that aims to streamline the development process, improve data accessibility, and enhance the management of data entities and their relationships.

Building the global look-aside index may require processing a change capture stream, which contains data in the storage schema format. However, the index may need to be built using the API schema format to maintain consistency and compatibility with the application's data model. Converting records from the storage schema to the API schema can be a complex and maintenance-intensive task if custom transformation logic is used.

The global look-aside index solution provides a novel approach to address this challenge. Instead of maintaining custom transformation logic, the global look-aside index leverages the source of truth system to perform the schema conversion. When the index receives a change capture stream record in the storage schema format, it can extract the primary key from the record. The index builder can then make a request to the corresponding REST system, which serves as the source of truth for that particular entity, using the extracted primary key.

The source of truth system, upon receiving the request with the primary key, retrieves the record and returns it back to the global look-aside index in the API schema format. This approach ensures that the global look-aside index is built using the same schema format as the one used by the application, maintaining consistency and eliminating the need for custom transformation logic.

To illustrate this process, consider an example where the global look-aside index receives a change capture stream from the user profile entity. The stream record contains data in the storage schema format, such as {id: 1, fname=Sid, lname=Agarwal}. The global look aside index extracts the primary key id: 1 from the record and makes a request to the user profile REST system using this key. The user profile REST system retrieves the corresponding record and returns it back to the index builder in the API schema format, like {id: 1, name=“Sid Agarwal”}.

By leveraging the source of truth system to perform the schema conversion, the global look aside index simplifies the index building process and reduces the maintenance overhead associated with custom transformation logic. This approach ensures that the global look-aside index remains in sync with the application's data model and can effectively support the relational querying capabilities highlighted above.

### General Overview-New Entity Hosting

Introducing an additional application data entity into the application ecosystem is another challenge addressed by the disclosed techniques. Currently, product and development teams at the provider are required to undertake a series of detailed and labor-intensive steps whenever a new REST resource needs to be added. This process includes creating the storage schema, provisioning and hosting a new REST service and a new database, writing API-to-storage conversion code, and, in some instances, creating a new message processor, among other tasks. Each of these steps adds to the overall complexity and duration needed to deploy an additional application data entity into production, which, as it stands, can take months to accomplish. Similarly, updating existing application data entities requires a subset of these steps, further highlighting the inefficiencies and potential bottlenecks within the current system.

This situation presents several challenges for the provider of the multi-user application, notably in terms of agility and the ability to rapidly respond to changing application requirements or to innovate within their product offerings. The extended timeframe needed to introduce or update data entities can significantly delay project timelines, impact product evolution, and strain resources. In a fast-paced and competitive application environment, these delays and complexities can hinder the provider's ability to innovate and maintain a competitive edge. Therefore, there is a pressing need for a solution that streamlines this process, reduces the time and effort required to manage data entities, and enhances the overall efficiency and agility of the product development lifecycle.

The managed entity solution of the techniques addresses the complexities and delays currently experienced by the provider's product and development teams when introducing or updating data entities within their ecosystem. This solution is designed to significantly streamline the process, enhancing the efficiency, agility, and capability of the provider to manage its application data entities more effectively.

In an embodiment, efficiency in onboarding an additional application data entity is achieved by entity owners to define their schemas and behaviors as code. This method reduces the time from conception to production for additional data entities, cutting down the introduction and consumption process to less than a day.

In an embodiment, the onboarding process is simplified eliminating the need for manual steps involved in schema creation, database provisioning, and API-storage conversion, among others.

In an embodiment, once an additional application data entity is onboarded, the entity is integrated into a global graph, making it immediately queryable within the rich relational context of provider's data ecosystem.

In an embodiment, the techniques encompass a rich query interface that facilitates sophisticated operations, such as filter, join, and search capabilities across the graph, enhancing the ability to extract insights and value from the interconnected data.

In an embodiment, the process of adding new indices, relationships, or attributes to data entities is fully automated and made self-serve, thereby significantly reducing the complexity and effort required for entity updates. This feature ensures that the data model can evolve quickly and efficiently in response to changing requirements or insights, without the need for extensive manual intervention.

In an embodiment, entity owners are relieved of the need to host services or manage any multi-products for their entities. Instead, entities are hosted on managed entity solution, which handles the underlying infrastructure and operational concerns. This allows product teams to focus more on developing and refining the functionalities and features of their applications, rather than being bogged down by the technicalities of hosting and managing data entities.

The foregoing and other embodiments will now be described with respect to the figures.

### Example System and Method for Transforming a Large-Scale Multi-User Application Provider'S Application Data Management with a Unified Graph Interface and Application-Logic Hosting

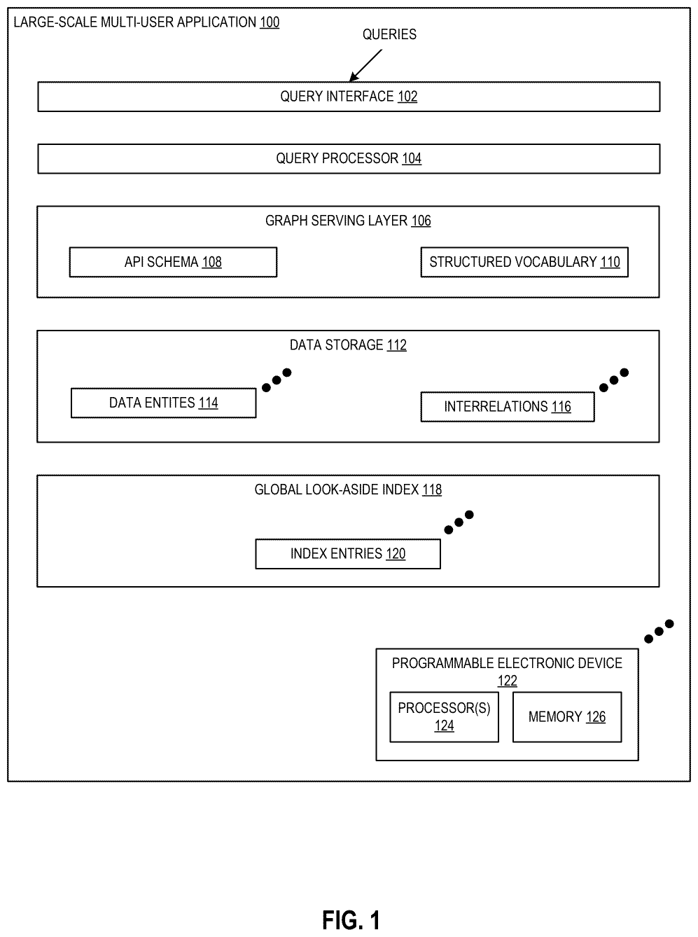

Turning now to FIG. 1, it illustrates a system implementing a method for managing highly relational application data in a large-scale multi-user application (100). The method begins by establishing a graph serving layer (106) within the application programming interface (API) schema (108) of the multi-user application (100). This graph serving layer (106) provides a structured vocabulary (110) that describes the various data entities (114) and the interrelations (116) between these entities within the application.

The data entities (114) and the data representing their interrelations (116) are stored in accordance with the structure provided by the graph serving layer (106). To enable efficient querying of these data entities, a global look-aside index (118) is generated. This index contains entries (120) for each of the data entities (114) and supports filter and join operations over these entries.

When a query is received via the API schema (108), specifying filter or join operations on a set of the data entities (114), the method retrieves the data responsive to this query. This is done by accessing the global look-aside index (118) to identify the entries corresponding to the relevant data entities and then performing the specified filter or join operations on these identified entries.

Finally, the retrieved data that is responsive to the query is returned via the API schema (108). All of these steps are performed by one or more processors (124) of the system implementing the multi-user application (100). This method provides an efficient way to manage and query highly relational data within a large-scale application.

Consider a concrete example of a social media application that manages user profiles, posts, comments, and relationships between users. In this context, the system and method of FIG. 1 could be applied first by the social media application (100) establishing a graph serving layer (106) within its API schema (108). This graph serving layer (106) defines a structured vocabulary (110) for the key data entities in the application, such as User, Post, Comment, and Relationship. It also captures the interrelations (116) between these entities, such as a User creating a Post, a Post having many Comments, and Users having Relationships with other Users.

The data for these entities (114) and their interrelations (116) are stored in the system in accordance with the structure defined by the graph serving layer (106). A global look-aside index (118) is generated, which contains entries (120) for each User, Post, Comment, and Relationship. This index supports efficient filtering and joining operations.

When a query is received via the API schema (108), for example, “Find all Posts by Users who are friends with User X”, the system uses the global look-aside index (118) to quickly identify the relevant User entries based on their Relationship with User X, and then finds all Post entries associated with these Users. The specified filtering and joining operations are performed on these identified entries.

The resulting set of Posts is then returned via the API schema (108) as the response to the query. All of these operations are performed by the processors (124) of the servers running the social media application (100). This enables the social media application to efficiently manage and query its highly interconnected data, such as finding posts by friends of a user, despite the large scale of the application and its user base.

### Large-Scale Multi-User Application

The large-scale multi-user application (100) is a software system designed to serve a large number of users simultaneously, handling significant amounts of data and complex relationships between various data entities. This application could take many forms, such as a social media platform, an e-commerce marketplace, a collaborative work management system, or an online gaming environment.

Characteristics of this application (100) are its scale and the highly relational nature of its data. “Large-scale” implies that the application is designed to handle a high volume of users, potentially millions or even billions, and large amounts of data generated by these users. “Multi-user” indicates that the application supports concurrent access by multiple users, who can interact with each other and with the application's data in real-time.

The application (100) manages various types of data entities (114), such as user profiles, product listings, blog posts, tasks, or game characters, depending on the specific domain. These data entities are not isolated but are interconnected through complex relationships (116). For example, in a social media application, users are connected to each other through friendships, they interact with posts through likes and comments, and they join shared interest groups.

Managing and querying such interconnected data is a challenge in such large-scale multi-user applications. Traditional data management approaches often struggle with the scale and complexity, leading to issues with performance, consistency, and developer productivity. The techniques disclosed herein address these challenges by introducing a graph-based approach to structuring and querying the application's data, enabling efficient handling of complex relationships at scale.

### Query Interface

The query interface (102) is a mechanism through which the multi-user application (100) receives, and processes queries related to its data entities (114). The query interface (102) is integrated with the application programming interface (API) schema (108). This means that queries are received, and results are returned through the same API that is used for other interactions with the application, ensuring a consistent and unified interface.

The query interface (102) supports queries that involve filter operations and join operations on the data entities (114). Filter operations allow for the selection of a subset of data entities based on specific criteria, such as “all users above age 30” or “all posts containing the keyword ‘tech’”. Join operations, on the other hand, allow for the combining of data from multiple related entities, such as “all comments on posts made by user X” or “all products ordered by users who live in city Y”.

When a query is received via the query interface (102), it is processed by the application (100) including using the global look-aside index (118) is used to efficiently identify the relevant data entity entries (120) based on the specified filter and join criteria. The actual filter and join operations are then performed on these identified entries to generate the final result set. This result set, containing the data entities that match the query criteria, is then returned to the querying client via the query interface (102), again using the standard API schema (108). By providing this powerful and flexible query interface (102), the method enables the multi-user application (100) to efficiently retrieve and combine data from its complex web of interrelated data entities (114), without the need for complex, ad-hoc querying logic.

In an embodiment, the query interface (102) offers a Fluent API or a similar type of API. A Fluent API is designed to provide a more readable, expressive, and intuitive way of constructing queries, making client code more understandable and maintainable.

In this embodiment, the Fluent API could be built on top of the application programming interface (API) schema (108). It would provide a set of methods and interfaces that developers can use to build up complex queries step by step, with each method call returning an object that can be further acted upon, allowing for method chaining.

For example, consider a social media application where the query intent is to find “all users above age 30 who have made a post in the last week”. Using a Fluent API, this query could be expressed as:

$$var result = userQuery \qquad 01$$

$$. Where ( u \text{=>} u . Age > 30 ) \qquad 02$$

$$. WhereHas ( u \text{=>} u . Posts , p \text{=>} p . CreatedAt > DateTime . Now . AddDays ( - 7 ) ) \qquad 03$$

$$. Select ( u \text{=>} new \{ u . Name , u . Email \} ) ; \qquad 04$$

In this example, userQuery is an object provided by the Fluent API, representing the base query on the User entity. The Where method applies a filter condition on the User's Age property. The WhereHas method performs a join-like operation, filtering the Users based on a condition on their related Posts. Finally, the Select method specifies the shape of the result set.

Behind the scenes, these method calls would be translated into the corresponding filter and join operations on the global look-aside index (118), as disclosed herein. The Fluent API provides a more developer-friendly abstraction over these low-level operations.

The result of the query, containing the selected data fields for the matching User entities, would be returned via the same Fluent API object, maintaining a consistent interface throughout the query lifecycle.

By offering a Fluent API or similar interface, this embodiment enhances the usability and expressive power of the query interface (102), making it easier for developers to construct complex queries over the application's data graph, while still benefiting from the efficient query processing enabled by the underlying graph serving layer (106) and global look-aside index (118).

### Query Processor

The query processor (104) is responsible for handling the queries received through the query interface (102), interacting with the graph serving layer (106) and the global look-aside index (118) to efficiently retrieve the requested data, and returning the results back through the query interface (102).

When a query is received via the query interface (102), the query processor (104) first analyzes the query to determine the specific data entities (114) and interrelations (116) that are involved. It identifies the filter and join operations specified in the query, which define the conditions that the requested data must satisfy.

Next, the query processor (104) interacts with the graph serving layer (106) to navigate the structured vocabulary (110) that describes the data entities (114) and their interrelations (116). This allows it to determine which specific data entity instances need to be retrieved based on the query conditions.

To efficiently locate these required data entity instances, the query processor (104) leverages the global look-aside index (118). This index, which is generated and maintained by the method, contains entries (120) for each data entity instance, organized in a way that supports fast filtering and joining operations.

Using the information from the structured vocabulary (110) and the query conditions, the query processor (104) constructs an efficient lookup operation on the global look-aside index (118). This lookup operation identifies the specific index entries that match the filter conditions and satisfy the required join relationships.

Once the relevant index entries have been identified, the query processor (104) retrieves the corresponding data entity instances from the underlying data storage. It then applies any remaining query operations, such as sorting, grouping, or aggregation, to generate the final result set.

Finally, the query processor (104) returns this result set, containing the requested data in the structure specified by the query, back through the query interface (102) to the client that initiated the query.

Throughout this process, the query processor (104) optimizes the query execution by minimizing the amount of data that needs to be retrieved and processed, leveraging the efficient indexing and lookup capabilities provided by the global look-aside index (118). This allows for handling complex queries over large-scale, highly relational data in an efficient and scalable manner.

For example, consider the operation of the query processor (104) in the context of a social media application. Suppose a client submits a query through the query interface (102) to find “all users who have made a post in the last week and have more than 1000 followers”.

Upon receiving this query, the query processor (104) analyzes it to identify the involved data entities and operations. In this case, the main data entities are User and Post, and the query includes a filter operation on the User's follower count and a join operation between User and Post based on the creation date of the Post.

The query processor (104) then consults the graph serving layer (106) to understand the structure and relationships of the User and Post entities, as defined in the structured vocabulary (110). This information helps the query processor determine how to navigate the data graph to find the required entities.

Next, the query processor (104) constructs a lookup operation on the global look-aside index (118). It searches for index entries (120) that correspond to User entities with more than 1000 followers. For each matching User entry, it then navigates to the associated Post entries, filtering them to include only those created within the last week.

This lookup operation efficiently identifies the specific User and Post instances that satisfy the query conditions, without needing to scan through the entire dataset. The query processor (104) retrieves these matching entity instances from the underlying data storage.

Finally, the query processor (104) constructs the result set, which includes the matching User entities along with their qualifying Posts. This result set is returned to the client through the query interface (102).

Throughout this process, the query processor (104) leverages the structured information provided by the graph serving layer (106) and the efficient indexing capabilities of the global look-aside index (118) to minimize the amount of data that needs to be processed. This allows it to quickly and efficiently handle the complex query.

The graph serving layer (106) serves as an intermediate layer between the application programming interface (API) schema (108) and the underlying data storage (112), providing a structured and efficient way to represent and navigate the complex relationships between the application's data entities (114).

A function of the graph serving layer (106) is to establish a structured vocabulary (110) that describes the data entities (114) and their interrelations (116) within the context of the multi-user application (100). This vocabulary defines the types of entities that exist in the application (such as User, Post, Comment), the properties associated with each entity type (such as a User's name, age, email), and the types of relationships that can exist between entities (such as a User creating a Post, a Post having many Comments).

By providing this structured representation of the application's data model, the graph serving layer (106) enables the other components, such as the query processor (104), to efficiently navigate and query the data graph. When a query is received through the query interface (102), the query processor (104) consults the graph serving layer (106) to understand the structure and relationships of the involved data entities, allowing it to construct efficient lookup operations on the global look-aside index (118).

The graph serving layer (106) is also used to maintain the integrity and consistency of the application's data. When additional data entities are created or existing entities are updated, the graph serving layer (106) ensures that these changes adhere to the structured vocabulary (110) and maintain the correct relationships with other entities. This enforcement of data consistency at the graph level simplifies the development of higher-level application features and ensures that the underlying data remains reliable and navigable.

In terms of implementation, the graph serving layer (106) can leverage various graph-based data models and technologies, such as graph databases, graph query languages, or graph processing frameworks. The specific choice of technology may depend on factors such as the scale of the application, the complexity of its data relationships, and the performance requirements for query processing.

### API Schema

The API schema (108) serves as the interface through which the multi-user application (100) exposes its functionality and data to external clients, such as web browsers, mobile apps, or other services.

The API schema (108) defines the structure, format, and protocols for interacting with the application's data and services. It specifies the available endpoints (such as URLs) for accessing different resources, the HTTP methods (such as GET, POST, PUT, DELETE) that can be used to interact with these resources, and the format of the data that is exchanged (such as JSON or XML).

In the context of the system and method of FIG. 1, the API schema (108) is tied to the graph serving layer (106). The structured vocabulary (110) defined by the graph serving layer, which describes the application's data entities (114) and their interrelations (116), is exposed through the API schema. This allows clients to interact with the application's data using a consistent and well-defined interface, regardless of the underlying implementation details.

For example, the API schema (108) may define endpoints for retrieving user profiles, creating new posts, commenting on existing posts, or querying the relationships between users. These endpoints would correspond to the data entities and relationships defined in the structured vocabulary (110) of the graph serving layer (106).

The API schema (108) also supports the query interface (102). Queries are submitted to the application through the API endpoints defined in the schema, using the specified data formats and protocols. The query processor (104) then interprets these queries, consults the graph serving layer (106) to understand the involved data entities and relationships, and returns the results back to the client through the API schema.

In addition to defining the structure of the API, the API schema (108) also handles important aspects such as authentication, authorization, and data validation. It ensures that only authorized clients can access the application's data and services, and that the data exchanged through the API conforms to the expected formats and constraints.

As an example of the API schema (108) for a social media application, the API schema might define the endpoints and data formats for interacting with the application's core data entities, such as User, Post, Comment, and Relationship.

For instance, the API schema may include the following endpoints:
/users/{userId}: A GET endpoint for retrieving the profile information of a specific user, identified by their userId. The response would include details such as the user's name, email, bio, and profile picture, formatted as a JSON object.
/users/{userId}/posts: A GET endpoint for retrieving the list of posts created by a specific user. The response would include an array of post objects, each containing the post's text content, timestamp, and metadata.
/posts: A POST endpoint for creating a new post. The request would include the post's text content and any associated metadata (such as location or tags) in the JSON payload. The response would include the newly created post object, along with its unique identifier.
/posts/{postId}/comments: A GET endpoint for retrieving the list of comments on a specific post, identified by its postld. The response would include an array of comment objects, each containing the comment's text content, author, and timestamp.
/users/{userId}/relationships: A GET endpoint for retrieving the list of relationships (such as friends or followers) for a specific user. The response would include an array of user objects representing the related users.

These endpoints align with the structured vocabulary (110) defined by the graph serving layer (106), which specifies the User, Post, Comment, and Relationship entities and their associated properties and relationships.

The API schema (108) would also specify the data formats for exchanging information through these endpoints. For example, it may require that all timestamps be formatted as ISO 8601 strings, that user email addresses be validated against a specific regular expression pattern, or that post text content be limited to a certain number of characters.

In addition to these data-specific endpoints, the API schema (108) would also include endpoints for authentication and authorization. For example, it may define a/login endpoint that accepts a username and password and returns an access token, which must be included in the headers of all subsequent requests to authenticate the client.

By providing this well-defined and standardized interface, the API schema (108) enables clients (such as mobile apps or third-party services) to interact with the social media application in a consistent and predictable way. It abstracts away the complexity of the underlying data model and storage implementation and provides a clean separation between the application's internal logic and its external interface.

Developers can consult the API schema (108) documentation to understand how to retrieve and manipulate the application's data, without needing to worry about the details of how that data is stored or processed internally. This promotes a modular and maintainable architecture and facilitates the development of a rich ecosystem of client applications and services around the core social media platform.

### Structured Vocabulary

The structured vocabulary (110) serves as a formal, machine-readable definition of the data model underlying the multi-user application (100).

The structured vocabulary (110) defines the types of data entities (114) that exist within the application (100), along with their properties and the relationships (116) that can exist between them. It provides a standardized way to represent and reason about the application's data, independent of the specific implementation details of the underlying storage system.

For example, in a social media application, the structured vocabulary (110) might define entities such as User, Post, Comment, and Relationship. For each entity type, it would specify the relevant properties, such as a User's name, email, and profile picture, a Post's text content and timestamp, or a Comment's author and parent Post.

The structured vocabulary (110) also defines the types of relationships (116) that can exist between these entities. For instance, it might specify that a User can have a “posted” relationship with a Post, indicating that the User created that Post. Similarly, it might define a “commented” relationship between a User and a Comment, and a “parent” relationship between a Comment and a Post.

By providing this formal, structured definition of the application's data model, the structured vocabulary (110) enables the other components of the system, such as the query processor (104) and the global look-aside index (118), to reason about and navigate the complex web of relationships between the data entities.

When a query is received through the query interface (102), the query processor (104) consults the structured vocabulary (110) to understand the types of entities and relationships involved in the query. This allows it to construct efficient lookup operations on the global look-aside index (118) and to correctly interpret the results.

The structured vocabulary (110) also maintains data consistency and integrity. When new data is added to the application, or existing data is updated, the graph serving layer (106) ensures that these changes adhere to the definitions laid out in the structured vocabulary. This enforcement of data consistency at the model level helps to prevent data corruption and ensures that the application's data remains well-structured and easily queryable.

In terms of implementation, the structured vocabulary (110) can be expressed using various data modeling languages or schemas, such as GraphQL, JSON Schema, or custom domain-specific languages. The choice of language may depend on factors such as the complexity of the data model, the need for validation and type checking, and the compatibility with other tools and frameworks in the application's technology stack.

Overall, the structured vocabulary (110) provides a clear, formal definition of the application's data model, which serves as the foundation for the graph-based data management and querying capabilities provided by the system and the method of FIG. 1. By decoupling the data model from the implementation details, it enables a flexible and maintainable architecture that can evolve over time to meet the changing needs of the application (100) and its users.

As an example of the structured vocabulary (110) for a social media application, it might define the main data entities and their relationships within the application.

For example, the core entities in the structured vocabulary might include:
User: Represents an individual user of the social media application. Properties of the User entity might include any or all of: id (unique identifier); name (user's full name); email (user's email address); bio (user's self-description); or profilePicture (URL of the user's profile picture).
Post: Represents a piece of content posted by a User. Properties of the Post entity might include any or all of: id (unique identifier); text (the text content of the post); timestamp (the time when the post was created); or author (the User who created the post.
Comment: Represents a response or reaction to a Post, written by a User. Properties of the Comment entity might include any or all of: id (unique identifier); text (the text content of the comment); timestamp (the time when the comment was created); author (the User who wrote the comment); or parentPost (the Post that the comment is responding to).
Relationship: Represents a connection between two Users, such as a friendship or following relationship. Properties of the Relationship entity might include any or all of: id (unique identifier); type (the type of relationship, e.g., “friend” or “follower”); sourceUser (the User who initiated the relationship); or targetUser (the User who is the recipient of the relationship).

In addition to defining these entities and their properties, the structured vocabulary (110) might also specify the relationships that can exist between them:

A User can have an “authored” relationship with multiple Posts, indicating that the User created those Posts.

A Post can have an “authored by” relationship with a single User, indicating the User who created it.

A Comment can have an “authored by” relationship with a single User, indicating the User who wrote it.

A Comment can have a “parent” relationship with a single Post, indicating the Post that it is responding to.

A Post can have a “comments” relationship with multiple Comments, indicating the Comments that have been made on that Post.

A User can have a “friends” or “followers” relationship with multiple other Users, indicating their social connections.

This structured vocabulary (110) provides a clear, formal definition of the data model for the social media application. It specifies the types of entities that exist, the properties associated with each entity, and the types of relationships that can exist between entities.

By providing this standardized representation of the application's data, the structured vocabulary (110) enables the graph serving layer (106) to enforce data consistency and integrity and allows the query processor (104) to efficiently navigate and query the complex web of relationships between entities.

For example, when a new Post is created, the graph serving layer (106) can consult the structured vocabulary (110) to ensure that the Post has a valid “authored by” relationship with a User entity. When a query is received to retrieve all Comments on a given Post, the query processor (104) can use the structured vocabulary (110) to navigate from the Post entity to its related Comment entities via the “comments” relationship.

### Data Storage

The data storage (112) component is responsible for the persistent storage and retrieval of the application's data entities (114) and the relationships (116) between them.

In the context of the graph-based data management system depicted in FIG. 1, the data storage (112) operates with the graph serving layer (106). The graph serving layer (106) defines the structured vocabulary (110) that describes the types of entities and relationships that exist in the application (100). The data storage (112) is then responsible for physically storing instances of these entities and relationships in a way that aligns with this structured vocabulary.

The specific implementation of the data storage (112) can vary depending on the needs of the application. It could be a traditional relational database management system (RDBMS), a NoSQL database, a graph database, or a combination of different storage technologies. The choice of storage system may depend on factors such as the scale of the data, the complexity of the relationships, the required query performance, and the existing technology stack of the application.

Regardless of the specific implementation, the data storage (112) efficiently stores and retrieves entities and relationships in a way that is consistent with the graph-based data model defined by the graph serving layer (106).

When a new entity is created (e.g., a new User in a social media application), the graph serving layer (106) ensures that it adheres to the structure defined in the vocabulary (110), and then passes it to the data storage (112) for persistent storage. Similarly, when a new relationship is established between entities (e.g., a User “likes” a Post), this relationship is stored in the data storage in a way that reflects the defined relationship type.

The data storage (112) is also responsible for supporting the retrieval of entities and relationships in response to queries. When a query is processed by the query processor (104), it may need to retrieve specific entities or traverse relationships from the data storage. The efficiency of these retrieval and traversal operations is critical to the overall performance of the system.

To support efficient querying, the data storage (112) may employ various indexing and caching strategies. This is where the global look-aside index (118) is useful. This index (118) provides a secondary access path to the data, optimized for the kinds of queries that are common in the application (100). By maintaining this index (118) alongside the primary data storage (112), the system can significantly speed up query processing times.

### Data Entities

The data entities (114) represent the core data objects or resources that the application (100) operates on and manages.

In a typical application, data entities (114) could represent a wide variety of things, depending on the domain and purpose of the application. For example:

In a social media application, data entities might include Users, Posts, Comments, and Media (photos, videos).

In an e-commerce application, data entities might include Products, Orders, Customers, and Suppliers.

In a project management application, data entities might include Projects, Tasks, Teams, and Milestones.

Each type of data entity (114) is defined in the structured vocabulary (110) of the graph serving layer (106). This definition specifies the properties or attributes that instances of the entity will have. For example, a User entity might have properties like id, name, email, and profile picture. A Post entity might have properties like id, text content, timestamp, and author.

Instances of these data entities (114) are created and stored in the data storage (112) when the application (100) is used. For example, when a new user signs up for a social media application, a new instance of the User entity is created with the provided details and stored persistently.

Data entities (114) in this graph-based system are connected to each other via relationships (116), which are also defined in the structured vocabulary (110). For example, a Post entity might be connected to a User entity via an “authored by” relationship, indicating which user created the post. A Post entity might also be connected to multiple Comment entities via a “comments” relationship, indicating the comments made on that post.

These relationships (116) between data entities (114) form a complex graph or network, which the query processor (104) can efficiently navigate using the global look-aside index (118) when processing queries. This allows for powerful and expressive queries that can traverse multiple levels of relationships, such as “find all comments made by friends of friends of a given user”.

The specifics of the data entities (114)—their definitions, properties, and relationships—are defined by the application developer based on the requirements of the application (100). The graph serving layer (106) provides the framework and tools for defining and working with these entities in a way that is efficient, scalable, and aligned with the graph-based data model.

### Interrelations

The interrelations (116), also known as relationships, represent the connections or associations between different data entities (114) in the application's data model.

In a graph-based data model, data is a complex network of interconnected entities. The interrelations (116) are what define these connections, providing structure and meaning to the data.

For example, in a social media application, a “friend” relationship might connect two User entities, indicating that those two users are friends on the platform. A “liked” relationship might connect a User entity to a Post entity, indicating that the user has liked that particular post. A “comment” relationship might connect a Comment entity to a Post entity, indicating which post the comment was made on.

These interrelations (116) are defined in the structured vocabulary (110) of the graph serving layer (106), alongside the definitions of the data entities (114) themselves. The vocabulary specifies the types of relationships that can exist between entities, and the entities that each relationship type can connect.

When instances of data entities are created and stored in the data storage (112), instances of the relationships between them are also created and stored. These relationship instances form the actual connections in the data graph.

The interrelations (116) support the querying capabilities of the system. When a query is processed by the query processor (104), it may need to navigate across these relationships to find the requested data. For example, a query might ask for “all posts liked by friends of a given user”. To answer this query, the system would need to traverse the “friend” relationships from the given user to find their friends, and then traverse the “liked” relationships from those friends to find the posts they have liked.

The global look-aside index (118) is optimized to support efficient traversal of these relationships during query processing. It maintains pre-computed indexes of the relationships, allowing the query processor to quickly navigate from one entity to another based on the connecting relationships.

The power of the graph-based model lies in its ability to represent and query these complex, multi-hop relationships between entities. By making the interrelations (116) first-class citizens in the data model, alongside the entities (114) themselves, the system enables rich, expressive queries that can uncover insights and connections that might be difficult or impractical to express in traditional relational data models.

### Global Look-Aside Index

The global look-aside index (118) manages highly relational application data in a large-scale multi-user application. Its purpose is to enable efficient querying of the plurality of data entities (114) stored in the application (100). The index comprises entries (120) corresponding to each data entity, and these entries (120) are organized in a way that facilitates fast and effective querying.

When a query is received via the API schema (108), the global look-aside index (118) is accessed to identify the relevant entries based on the specified filter or join operations. By supporting these operations, the index (118) allows for selecting a subset of data entities based on specific criteria and combining data from multiple entities based on their interrelations. The global look-aside index (118) acts as a secondary data structure alongside the primary data storage (112), providing an optimized way to access and retrieve data responsive to the queries. This indexing approach improves the system's performance and scalability, particularly when dealing with a large number of data entities and complex queries, by eliminating the need for exhaustive searches through all the data entities.

For example, consider a scenario where the multi-user application (100) is a social media platform, and the data entities (114) represent users, posts, and comments. The global look-aside index (118) can contain entries for each user, post, and comment, along with their respective attributes and interrelations. Now, suppose a query is received via the API schema (108) requesting all the posts made by a specific user within a certain date range, along with the comments on those posts. To answer this query, the system would first access the global look-aside index (118) and use the filter operations to identify the entries corresponding to the specified user and the date range. This would quickly narrow down the relevant posts without having to scan through all the post entities. Next, the system would perform a join operation using the interrelation data stored in the index (118) to retrieve the comments associated with each of the identified posts. The global look-aside index (118) enables efficient linking of the comment entities to their corresponding post entities. Finally, the retrieved data, consisting of the filtered posts and their associated comments, would be returned as the response to the query via the API schema (108). By leveraging the global look-aside index (118), the system can efficiently handle such complex queries involving multiple data entities and their interrelations, providing fast and accurate results to the users of the application (100).

### Index Entries

The index entries (120) of the global look-aside index (118) address challenges faced by the provider in managing highly relational data across siloed microservices. As described above, the provider's conventional architecture struggles to efficiently perform complex relational queries, such as joins and filters, across encapsulated data entities. The global look-aside index (118) tackles this issue by maintaining a separate set of entries (120) that aggregate information about the various data entities (114) and their interrelations (116) as defined in the graph serving layer (106).

Each entry (120) in the global look-aside index (118) corresponds to a specific data entity (114) and contains relevant information that facilitates efficient querying. This information might include the entity's primary key, attributes, and references to related entities based on the interrelations (116) defined in the graph serving layer (106). By maintaining this information in a separate, globally accessible structure, the index allows for rapid lookups, filtering, and joining of data across multiple entities without the need to directly query the individual microservices or their underlying databases.

When a query is received via the API schema (108) specifying filter or join operations on a set of data entities, the system can quickly retrieve the necessary information by accessing the corresponding entries (120) in the global look-aside index (118). This approach minimizes the need for complex, cross-service queries and enables efficient execution of relational operations. The result is a more streamlined and performant system that can effectively manage and query highly interconnected data while preserving the benefits of a microservice architecture, as highlighted above.

The method and system of FIG. 1 and the other figures can be implemented using one or more programmable electronic devices 122, such as servers, computers, or other processing units, which provide the necessary processors (124) and memory (126) for executing the steps of the method. These electronic devices typically include components such as central processing units (CPUs), random access memory (RAM), read-only memory (ROM), and storage devices like hard drives or solid-state drives (SSDs).

The processors (124) in these devices are responsible for executing the instructions of the computer program or software that implements the various steps of the method. This includes establishing the graph serving layer (106) in the API schema (108), storing the data entities (114) and their interrelations (116), generating and maintaining the global look-aside index (118), processing queries received via the API schema (108), retrieving data from the index (118), and returning the results back through the API schema (108).

The memory components (126), such as RAM and ROM, provide the necessary storage for the processors (124) to perform these tasks. RAM is used for storing temporary data and instructions that the processors need to access quickly during the execution of the method, while ROM can store permanent information such as the boot instructions for the electronic devices. The storage devices, like hard drives or SSDs, provide persistent storage for the data entities (114), interrelations (116), and the global look-aside index (118) itself.

In a distributed computing environment, which is common for large-scale multi-user applications, multiple programmable electronic devices may work together to provide the necessary processing power and memory for executing the method. This can involve dividing the tasks and data across different machines, with each one handling a specific subset of the workload. The electronic devices communicate and coordinate with each other through networking protocols and APIs to ensure the smooth operation of the overall system.

### New Data Entities

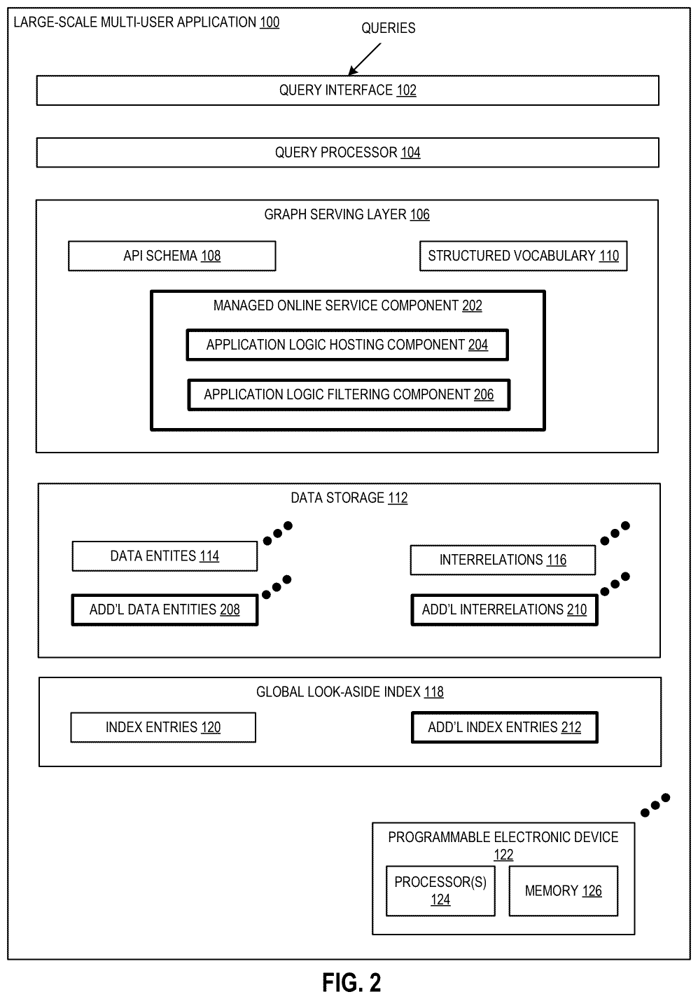

FIG. 2 illustrates an extension of the system and method of FIG. 1 that focuses on the creation and management of additional data entities (208) within the large-scale multi-user application (100). This extension leverages the managed online service component (202), which is integrated with the graph serving layer (106), to host application logic (204) for additional data entities (208).

When a request is received via the managed online service component (202) to create an additional data entity (208), the request includes a data definition for the entity and specifies its relationships with existing data entities (114). The system then creates the additional data entity (208) based on this definition and stores it in accordance with the graph serving layer (106), along with the data representing its relationships to other entities.

To maintain the integrity and functionality of the global look-aside index (118), the system updates the index to include entries corresponding to the newly created data entity (208). This ensures that the new entity can be queried in conjunction with the existing data entities (114), preserving the relational querying capabilities of the system.

Furthermore, the managed online service component (202) hosts application logic (206) for filtering collections of data entities, including the new entity (208), based on specific rulesets. This hosting feature allows for the efficient management and querying of data entities without the need for extensive manual intervention or custom implementation by the application developers.

For example, suppose the multi-user application (100) is a professional networking platform, and a new feature is being introduced to allow users to create and join online learning courses. The development team submits a request via the managed online service component (202) to create a new “Course” data entity (208). The request includes a data definition for the “Course” entity, specifying attributes such as the course name, description, start date, and end date. The request also defines relationships between the “Course” entity and existing entities such as “User” (users can be instructors or students in a course) and “Organization” (courses can be offered by organizations).

The system creates the “Course” entity (208) based on the provided definition and stores it in accordance with the graph serving layer (106), along with the data representing its relationships to the “User” and “Organization” entities. The global look-aside index (118) is then updated to include entries for the “Course” entity, enabling it to be queried alongside the existing data entities.

Finally, the managed online service component (202) hosts application logic (206) for filtering collections of data entities, including the “Course” entity, based on specific rulesets. For example, this could include filtering courses by start date, end date, instructor, or organization, allowing for efficient querying and management of the course data.

The managed online service component (202) facilitates the creation, hosting, and management of additional data entities within the large-scale multi-user application (100). This component is integrated with the graph serving layer (106), allowing it to incorporate additional data entities (208) into the existing data model and enable efficient querying and filtering of these entities alongside the pre-existing ones.

A function of the managed online service component (202) is to host the application logic (204) for existing data entities (114) and interrelations (116) as well as additional data entities (208) and new interrelations (210). This means that when an additional data entity is created, the managed online service component (202) takes responsibility for managing the entity's behavior and functionality within the application. This includes handling tasks such as data validation, data access control, and any custom business logic associated with the entity.

By providing a centralized, managed service for hosting additional data entities (208), the system relieves application developers of the burden of implementing and maintaining custom logic for each new entity they introduce. Instead, developers can focus on defining the data model and relationships for the new entity, while the managed online service component (202) takes care of the underlying infrastructure and ensures the entity is properly integrated into the graph serving layer (106) and the global look-aside index (118).

Another feature of the managed online service component (202) is its ability to host application logic (206) for filtering collections of data entities, including the newly created entities, based on specific rulesets. This filtering capability allows for efficient querying and retrieval of data entities that match certain criteria, enabling developers to casily implement complex search and filtering functionality within their applications.

For example, consider a multi-user application for a retail company that manages product data, customer information, and order details. The application already has existing data entities for “Product,” “Customer,” and “Order.” Now, the company wants to introduce an additional data entity called “Promotion” to represent special offers and discounts associated with specific products.

The development team submits a request to the managed online service component (202) to create the new “Promotion” data entity (208). The request includes the data definition for the entity, specifying attributes such as the promotion name, description, start date, end date, and the associated product. The managed online service component (202) then creates the “Promotion” entity and integrates it into the graph serving layer (106), ensuring that the relationships between the “Promotion” entity and the existing “Product” entity are properly established and stored.

Furthermore, the managed online service component (202) hosts the application logic (206) for filtering collections of data entities, including the newly created “Promotion” entity. This could include filtering promotions by date range, associated product, or a combination of criteria. By hosting this filtering logic, the managed online service component (202) enables efficient querying and retrieval of promotion data, making it easy for developers to implement features like displaying active promotions for a specific product or retrieving all promotions within a given date range.

The application hosting logic (204) and application filtering logic (206) are components of the managed online service component (202) that enable efficient management and querying of data entities within the large-scale multi-user application (100).

The application hosting logic (204) is responsible for managing the behavior and functionality of additional data entities (208) created within the system. When an additional data entity is introduced, the application hosting logic (204) takes charge of implementing and executing the business rules, data validation, and access control associated with that entity. This logic ensures that the new entity adheres to the application's requirements and constraints, maintaining data integrity and consistency across the system.

For example, consider a project management application that introduces an additional data entity called “Task” to represent individual units of work within a project. The application hosting logic (204) for the “Task” entity would include rules such as ensuring that each task has a unique identifier, validating that the task's start date is earlier than its due date, and enforcing access control based on the user's role and permissions. By hosting this logic within the managed online service component (202), the system centralizes the management of the “Task” entity, making it easier to maintain and update as the application (100) evolves.

On the other hand, the application filtering logic (206) focuses on enabling efficient querying and retrieval of data entities based on specific criteria. This logic allows developers to define rulesets for filtering collections of data entities, including both existing and newly created entities. By hosting this filtering logic within the managed online service component (202), the system provides a centralized and optimized approach to querying data, reducing the need for custom query implementations across different parts of the application.

As an example of filtering logic (206), consider an e-commerce application that manages data entities such as “Product,” “Customer,” and “Order.” The application filtering logic (206) can enable developers to define rulesets for querying these entities based on various criteria. For instance, a ruleset could be created to filter products by category, price range, and availability status, allowing users to easily find products that match their specific requirements. Similarly, another ruleset could be defined to filter orders by date range, customer location, and order status, enabling efficient tracking and management of order fulfillment.

The additional data entities (208), new interrelations (210), and new index entries (212) enable the integration and management of new data within the large-scale multi-user application (100).

New data entities (208) represent the additional data structures that are created and incorporated into the application's data model as the system evolves and expands. These entities are defined by their attributes, relationships, and behaviors, and they are introduced to capture new types of information or to support new features and functionalities within the application. For example, in a social media application, an additional data entity called “Event” could be introduced to represent user-created events, with attributes such as event name, date, location, and description.

When an additional data entity (208) is created, it often establishes relationships or interrelations (210) with existing data entities in the system. These interrelations (210) define how the new entity connects to and interacts with other entities, forming a web of associations that represents the domain model of the application. For instance, in the social media application example, the new “Event” entity could have interrelations (210) with existing entities such as “User” (to represent event organizers and attendees) and “Location” (to represent the event venue).

To ensure that the additional data entities (208) and their interrelations (210) are efficiently queryable and accessible, the system creates new index entries (212) in the global look-aside index (118). These new index entries (212) correspond to the additional data entities (208) and contain key information such as the entity's primary key, attributes, and references to related entities based on the interrelations (210). By including these new index entries (212) in the global look-aside index (118), the system enables fast and efficient querying of the additional data entities (208) alongside the existing entities, without the need for costly and complex joins or cross-service queries.

For example, when the “Event” entity is introduced in the social media application, the system creates new index entries (212) for each event instance in the global look-aside index (118). These index entries (212) would contain the event's unique identifier, its attributes (such as name, date, and location), and references to the related “User” and “Location” entities based on the established interrelations (210). With these index entries (212) in place, the application can efficiently query and retrieve event data, filter events by specific criteria, and navigate the relationships between events and other entities in the system.

### Global Look-Aside Index Functionality

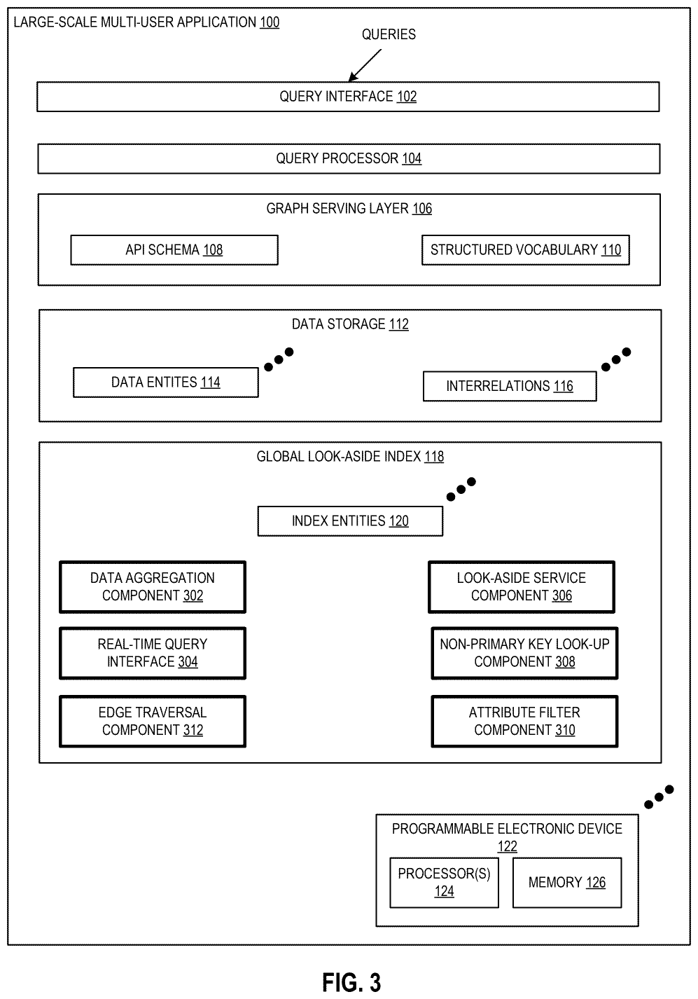

FIG. 3 illustrates an embodiment of the system and method of FIG. 1 that focuses on the specific functionalities and benefits provided by the global look-aside index (118).

One feature of the global look-aside index (118) is its ability to aggregate data records and relationships from multiple data entities (114) across the large-scale multi-user application (100). As mentioned above, the application's data architecture often suffers from siloed datasets due to the microservice-based isolation and encapsulation of data entities (114). The global look-aside index (118) overcomes these limitations by creating a unified view of the data, enabling efficient querying and traversal of relationships across different entities. Importantly, this aggregation is achieved without compromising the benefits of microservice architecture, such as the independence and scalability of individual services.

Another aspect of the global look-aside index (118) is its provision of real-time online querying capabilities. As highlighted above, the index allows for immediate access and manipulation of data from the various data entities (114). This real-time querying is useful for supporting dynamic application needs and enabling rapid innovation within the application ecosystem.

The global look-aside index (118) operates as a look-aside service, running in parallel with the primary data storage or source-of-truth datastores that maintain the actual data entities (114). This parallel operation ensures that the index does not intrude on or disrupt the core functionalities and operations of the underlying data storage systems. Instead, the index serves as a complementary layer that enhances querying capabilities without modifying the primary data stores.

The global look-aside index (118) facilitates efficient lookups by non-primary keys, attribute filters, and edge traversals. As mentioned above, these capabilities significantly improve the performance and flexibility of querying data from the various entities (114). By supporting lookups based on non-primary keys and attribute filters, the index allows for more targeted and precise data retrieval. Moreover, the ability to perform edge traversals enables efficient navigation and exploration of the relationships between different entities.

To illustrate, consider an example in the context of a large-scale e-commerce application (100). The application consists of multiple microservices handling data entities (114) such as products, orders, customers, and inventory. Each microservice maintains its own isolated datastore, leading to siloed datasets.

The global look-aside index (118) aggregates data records and relationships from these various entities, creating a unified view of the application's data. For instance, it captures the relationships between products and orders, customers and their purchase history, and inventory levels across different warehouses. This aggregation enables efficient querying and analysis of data across the entire application.

When a customer searches for a specific product, the global look-aside index (118) provides real-time online querying capabilities, allowing for immediate retrieval of relevant product information, including details such as price, availability, and customer reviews. The index operates as a look-aside service, running alongside the primary product datastore without interfering with its core operations.

Furthermore, the global look-aside index (118) facilitates efficient lookups based on non-primary keys, such as product categories or attributes. This capability allows customers to filter products based on specific criteria, such as color, size, or brand, enhancing the search experience. The index also supports edge traversals, enabling customers to explore related products or navigate through their purchase history seamlessly.

The global look-aside index (118) encompasses several components that collectively enable efficient querying and manipulation of data from the various data entities (114) in the large-scale multi-user application (100).

The data aggregation component (302) is responsible for collecting and consolidating data records and relationships from the multiple data entities (114) across the application (100). This component creates a unified view of the data, breaking down the silos that often exist due to the microservice-based architecture. By aggregating data from different sources, the data aggregation component (302) enables comprehensive querying and analysis of the application's data.

For example, in a healthcare application, the data aggregation component (302) might gather data from various entities such as patient records, medical history, prescriptions, and insurance information. This aggregation allows healthcare providers to access a complete view of a patient's health data, facilitating informed decision-making and improved care coordination.

The look-aside service component (306) ensures that the global look-aside index (118) operates in parallel with the primary data storage systems without interfering with their core functionalities. This component acts as a separate layer that enhances querying capabilities while leaving the source-of-truth datastores intact. By operating as a look-aside service, the index can provide additional querying features without modifying or disrupting the existing data storage infrastructure.

For example, in a financial application, the look-aside service component (306) could allow the global look-aside index (118) to offer advanced querying and analytics capabilities on top of the primary transaction database. This separate layer enables complex queries and insights without impacting the performance or integrity of the core financial data storage.

The real-time query interface (304) enables immediate access and manipulation of data from the various data entities (114) through the global look-aside index (118). This interface provides a seamless and responsive querying experience, allowing users to retrieve and interact with data in real-time. The real-time nature of the interface is crucial for supporting dynamic application needs and enabling rapid data-driven decision-making.

For example, in a social media application, the real-time query interface (304) could allow users to search for and retrieve relevant posts, profiles, and connections instantaneously. This real-time capability ensures that users have access to the most up-to-date information and can engage with the platform in a smooth and interactive manner.

The non-primary key look-up component (308) facilitates efficient data retrieval based on attributes other than the primary key. This component allows users to search for and access data using various criteria, such as secondary indexes or alternate identifiers. By supporting non-primary key lookups, the global look-aside index (118) offers more flexible and targeted querying capabilities.

For example, in an e-commerce application, the non-primary key look-up component (308) could enable customers to search for products based on attributes like brand, category, or price range, in addition to the primary product ID. This functionality enhances the user experience by allowing customers to find relevant products more easily and intuitively.

The edge traversal component (312) enables efficient navigation and exploration of the relationships between different data entities (114). This component allows users to traverse the interconnected data graph, following the edges that represent the relationships between entities. Edge traversal capabilities open up new possibilities for data analysis, recommendation systems, and uncovering hidden insights within the application's data.

For example, in a movie recommendation application, the edge traversal component (312) would allow users to explore the connections between movies, actors, directors, and genres. By traversing these relationships, the application can provide personalized movie recommendations based on a user's viewing history and preferences.

The attribute filter component (310) enables users to refine and narrow down their queries based on specific attributes or criteria. This component allows for the creation of complex filtering conditions, empowering users to precisely specify the data they need. Attribute filtering enhances the querying experience by providing more control and granularity over the returned results.

For example, in a human resources application, the attribute filter component (310) would allow managers to search for employees based on criteria such as job title, department, years of experience, or specific skills. By applying these filters, managers can quickly identify the most suitable candidates for a particular project or task.

### Preservation of Microservice Integrity and Encapsulation

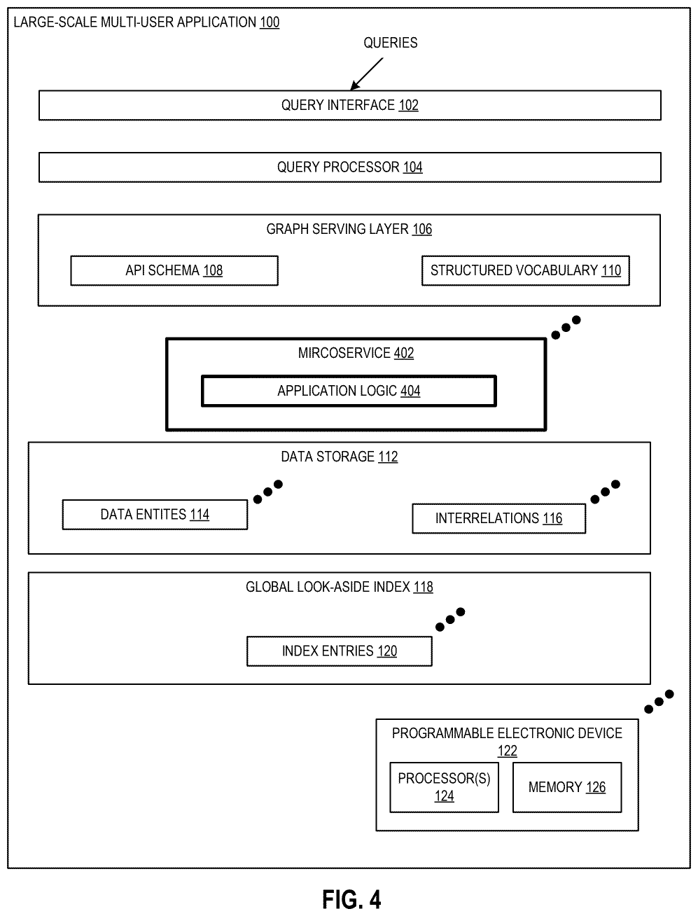

FIG. 4 illustrates an extension of the system and method of FIG. 1 that focuses on how the graph serving layer (106) and the global look-aside index (118) work together to efficiently query and manipulate data entities (114) while preserving the integrity and encapsulation of the microservices (402) that host these entities.

As mentioned above, the application's data architecture often involves microservices (402) that host and manage specific data entities (114). Each microservice (402) maintains its own application logic (404) for querying and manipulating the data entities (114) it is responsible for. This application logic (404) encapsulates the business rules, validation, and data access methods specific to each microservice (402).

The graph serving layer (106) maintains this application logic (404) within the respective microservices (402). By keeping the application logic (404) decentralized and confined to each microservice (402), the graph serving layer (106) preserves the autonomy and encapsulation of the microservices (402). This approach ensures that each microservice (402) retains control over its own data entities (114) and the associated querying and manipulation logic.

However, as highlighted above, the global look-aside index (118) enables efficient querying across multiple data entities (114) without compromising the encapsulation of the microservices (402). When executing queries over the data entities (114), the global look-aside index (118) does not relocate or duplicate the application logic (404) maintained within the microservices (402). Instead, it leverages its own indexing and querying capabilities to efficiently retrieve and combine data from multiple entities (114).

By operating independently of the microservices' application logic (404), the global look-aside index (118) preserves the integrity and encapsulation of the microservices (402). This separation of concerns allows the microservices (402) to focus on their specific responsibilities and maintain their own application logic (404), while the global look-aside index (118) takes care of the cross-entity querying and data aggregation.

Consider an example where a large-scale e-commerce application (100) with microservices (402) for products, orders, and customer data. Each microservice (402) maintains its own application logic (404) for querying and manipulating its respective data entities (114).

The product microservice (402) may have application logic (404) for retrieving product details, updating inventory, and calculating discounts. Similarly, the order microservice (402) may have application logic (404) for creating new orders, updating order status, and calculating shipping costs. The customer microservice (402) may have application logic (404) for managing customer profiles, preferences, and loyalty programs.

When a user searches for products based on specific criteria, such as category and price range, the global look-aside index (118) efficiently queries its own data structures to retrieve the relevant product information from the product entities (114). It does this without invoking the application logic (404) within the product microservice (402).

Similarly, when a user wants to view their order history, the global look-aside index (118) can efficiently retrieve the necessary data from the order entities (114) and the associated customer entities (114) without duplicating or relocating the application logic (404) maintained within the order and customer microservices (402).

By executing queries over the data entities (114) independently of the microservices' application logic (404), the global look-aside index (118) enables efficient cross-entity querying while preserving the integrity and encapsulation of the microservices (402). This approach strikes a balance between the benefits of microservice architecture, such as modularity and autonomy, and the need for efficient querying capabilities across the entire application (100).

### Global Look-Aside Index Operation

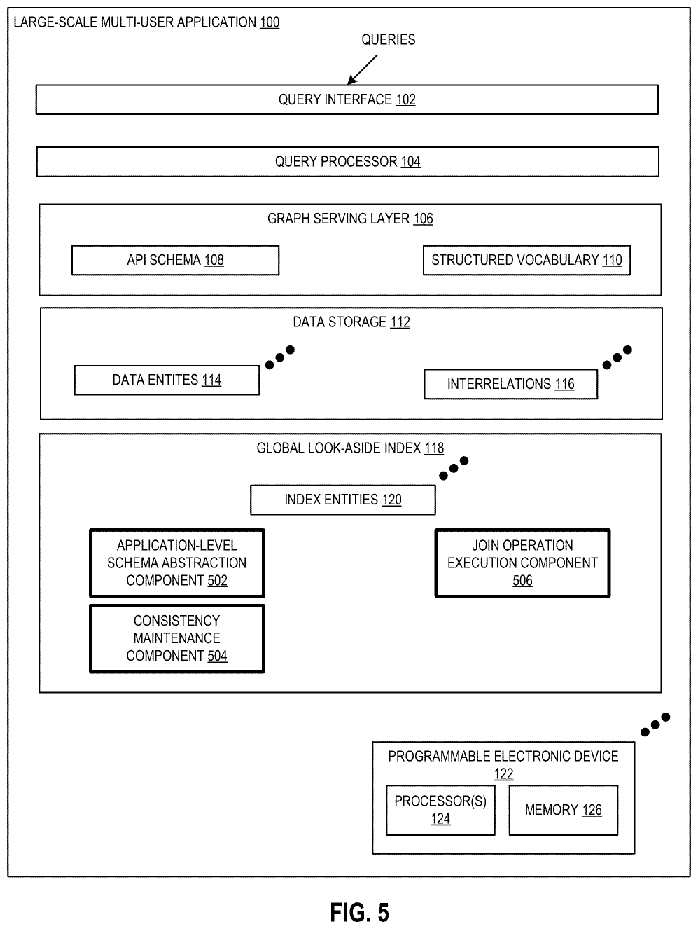

FIG. 5 illustrates an extension of the system and method of FIG. 1 highlighting how the global look-aside index (118) operates at an application-level schema abstraction, maintains consistency with the graph serving layer (106), and executes join operations to improve query performance and simplify client-side operations.

As mentioned above, conventional technologies often focus on per-query index generation at the storage level, which can limit the accessibility and flexibility of querying capabilities. In contrast, the global look-aside index (118) operates at an application-level schema abstraction, which is closer to how data from the plurality of data entities (114) is actually utilized within the large-scale multi-user application (100).

By working at this level of abstraction, the global look-aside index (118), via the application-level schema abstraction component 502, provides more intuitive and adaptable querying capabilities compared to storage-level approaches. It allows developers and users to interact with the data in a way that aligns with the application's business logic and requirements, rather than being constrained by the underlying storage schema.

Moreover, the global look-aside index (118), via the consistency maintenance component 504, maintains consistency with the graph serving layer (106) by working alongside existing application-level schemas without introducing additional layers of complexity. This seamless integration ensures that the index complements and enhances the existing data model and querying mechanisms without disrupting the overall architecture or requiring significant modifications to the application's codebase.

Another aspect is how the global look-aside index (118), via the join operation execution component 506, executes join operations over the entries (120) for the plurality of data entities (114). In conventional approaches, join operations are often performed on the client-side, which can lead to performance and complexity issues, especially when dealing with large datasets or complex queries.

In contrast, the global look-aside index (118) performs join operations at the index level itself. By executing these joins globally, the index can optimize query performance and reduce the burden on client-side operations. This approach simplifies the query process and improves the overall efficiency of data retrieval and manipulation within the application (100).

For example, consider a social media application (100) with data entities (114) representing users, posts, comments, and likes. The application's schema defines the relationships between these entities, such as users creating posts, posts receiving comments, and users liking posts or comments.

Conventional approaches might generate indexes at the storage level, focusing on optimizing individual queries based on specific access patterns. However, this approach can limit the flexibility and accessibility of querying capabilities, as it is tightly coupled to the underlying storage schema.

In contrast, the global look-aside index (118) operates at the application-level schema abstraction. It understands and indexes the relationships between users, posts, comments, and likes based on how they are defined and utilized within the social media application (100). This allows developers to query the data using application-specific concepts and terminology, such as retrieving all posts created by a particular user or finding the most liked comments on a given post.

Furthermore, the global look-aside index (118) maintains consistency with the graph serving layer (106) by integrating with the existing application-level schemas. It does not introduce any additional complexity or require modifications to the existing data model. This consistency ensures that the index can be easily incorporated into the application's querying mechanisms without disrupting the overall architecture.

When executing join operations, the global look-aside index (118) performs them at the index level. For example, if a query requires retrieving all posts along with their associated comments and likes, the index can efficiently join the relevant entries (120) for posts, comments, and likes, and return the combined result set. By executing these joins, the index improves query performance and reduces the need for complex client-side join operations, which can be resource-intensive and error-prone.

### Creating and Integrating New Application Data Entities into the Graph Serving Layer

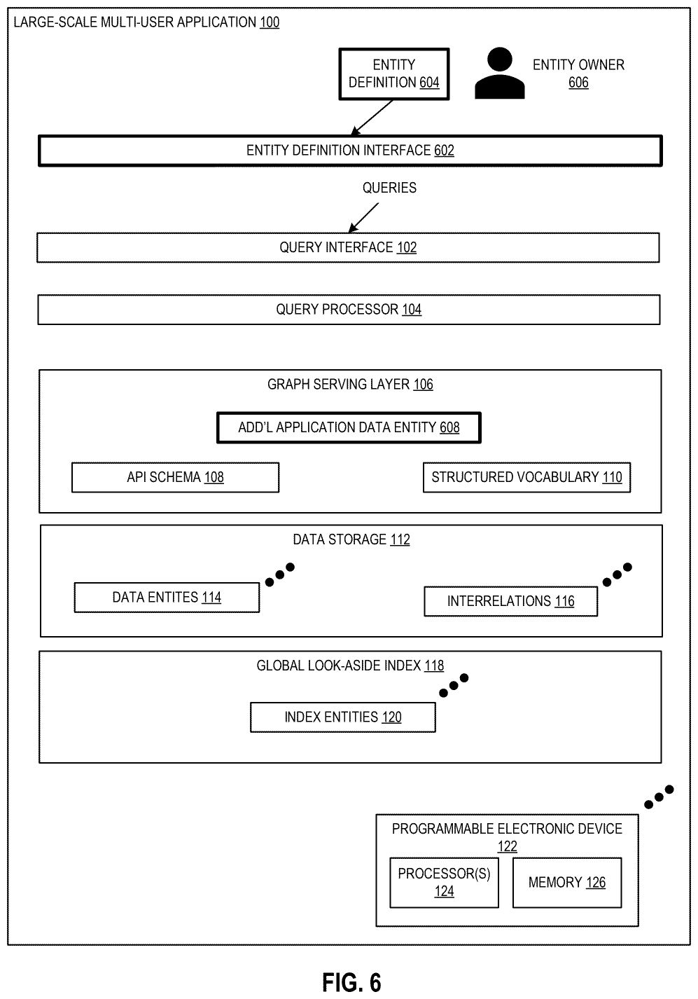

FIG. 6 illustrates an extension of the system and the method of FIG. 1 that focuses on the process of creating and integrating additional application data entities into the graph serving layer (106) using an entity definition interface (602). This approach addresses the challenges outlined above, which highlight the difficulties and time-consuming nature of introducing additional data entities in conventional systems.

As mentioned above, traditional approaches to adding additional data entities often involve a series of complex and time-consuming steps, such as creating storage schemas, provisioning databases, writing conversion code, and setting up message processors. This process can take months to complete, hindering the agility and responsiveness of the application development process.

The method and system of FIG. 6 addresses these challenges by providing an entity definition interface (602) that enables entity owners (606) to define the schema and behaviors for additional application data entities (608) as code. This interface simplifies the process of creating additional data entities by allowing entity owners to specify the structure, attributes, relationships, and behaviors of the entities in a programmatic way.

When an entity owner (606) wants to create an additional application data entity (608), they use the entity definition interface (602) to provide an entity definition (604). This definition includes all the necessary information about the entity's schema and behaviors, expressed as code. The entity definition interface (602) abstracts away the complexities of the underlying storage and infrastructure, making it easier for entity owners to focus on defining the logical structure and behavior of the entities.

Upon receiving the entity definition (604) through the entity definition interface (602), the system, using one or more processors (124), generates the additional application data entity (608) based on the provided definition. This generation process may involve automatically creating the necessary storage schemas, provisioning databases, and setting up the required infrastructure to support the new entity.

Once the additional application data entity (608) is generated, it is integrated into the graph serving layer (106). This integration process is completed within one day of receiving the entity definition (604). This rapid integration is a significant improvement over conventional approaches, which can take months to incorporate new entities into the system.

By reducing the time period from conception to production for additional application data entities, the agility and responsiveness of the application development process is enhanced. It allows entity owners to quickly define and introduce new entities into the system, enabling faster iteration and adaptation to changing business requirements.

For example, consider a large-scale e-commerce application that currently has data entities for products, orders, and customers. The marketing team wants to introduce an additional data entity called “Promotions” to represent special offers and discounts associated with specific products.

Using the entity definition interface (602), the marketing team, as the entity owner (606), defines the schema and behaviors for the “Promotions” entity (608) as code. They specify attributes such as the promotion name, description, start date, end date, and the associated product IDs. They also define any specific behaviors or rules related to the promotions, such as maximum discount percentages or expiration conditions.

Once the marketing team submits the entity definition (604) through the entity definition interface (602), the system generates the “Promotions” entity (608) based on the provided definition. It automatically creates the necessary storage schemas, provisions the required databases, and sets up the infrastructure to support the new entity.

Within one day of receiving the entity definition (604), the “Promotions” entity (608) is fully integrated into the graph serving layer (106). It becomes available for querying, manipulation, and integration with other entities in the e-commerce application. This rapid integration allows the marketing team to start using the “Promotions” entity almost immediately, enabling them to create and manage special offers and discounts efficiently.

### Onboarding Process for New Application Data Entities

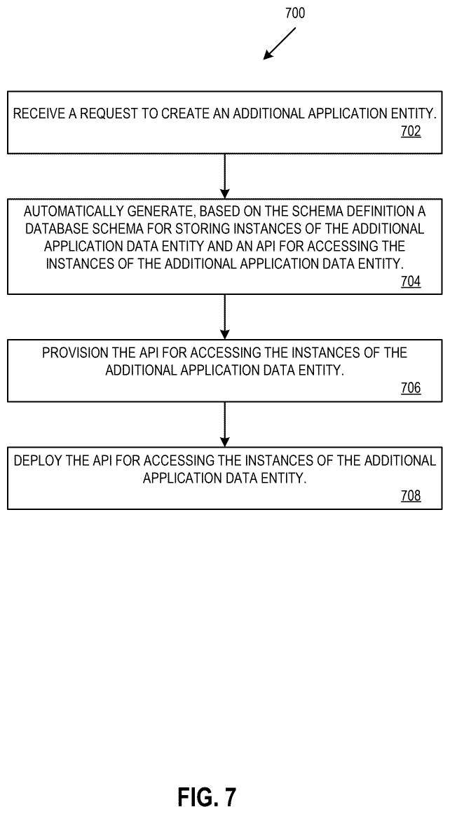

FIG. 7 illustrates a method (700) that focuses on simplifying the onboarding process for additional application data entities by automating the generation of database schemas, APIs, and provisioning of databases. This approach addresses the challenges outlined above, which highlight the complexity and time-consuming nature of manually performing these steps in conventional systems.

As mentioned above, introducing additional application data entities in traditional systems often involves a series of manual and labor-intensive tasks, such as creating storage schemas, provisioning databases, writing API-to-storage conversion code, and setting up message processors. These tasks require significant effort from development teams and can prolong the time needed to deploy new entities into production.

The method (700) addresses these challenges by automating several key steps in the onboarding process. When a request is received (702) to create an additional application data entity, the request includes a schema definition that specifies the structure and attributes of the entity. Based on this schema definition, the system, using one or more processors, automatically generates (704) a database schema for storing instances of the new entity. This eliminates the need for developers to manually design and create the storage schema, saving time and effort.

In addition to generating the database schema, the method also automatically generates (704) an application programming interface (API) for accessing the instances of the additional application data entity. The API provides a standardized way to interact with the entity, allowing other parts of the application to retrieve, create, update, and delete instances of the entity. The automatic generation of the API relieves developers from the task of manually writing and implementing the necessary endpoints and methods.

Once the database schema and API are generated, the system automatically provisions (706) a database for storing the instances of the additional application data entity based on the generated schema. This provisioning step ensures that the required storage infrastructure is set up and ready to accommodate the new entity. By automating the database provisioning, the method (700) eliminates the need for manual configuration and setup, further streamlining the onboarding process.

Finally, the generated API is deployed (708), making it available for use by other parts of the application. The API includes functionality for converting between the API-level representation of the entity instances and the storage-level representation. This conversion functionality abstracts away the details of the underlying storage implementation, allowing developers to interact with the entity using high-level API concepts rather than low-level storage details.

By automatically generating the database schema and API, provisioning the database, and deploying the API, the method (700) significantly simplifies the onboarding process for additional application data entities compared to conventional approaches. It eliminates the need for manual performance of these steps, reducing the effort and time required to introduce new entities into the system.

As an example, consider a social media application that currently has data entities for users, posts, and comments. The development team wants to introduce an additional data entity called “Events” to represent user-created events and gatherings.

The development team submits a request to create the “Events” entity, including a schema definition that specifies attributes such as the event name, description, date, time, location, and the associated user who created the event. Upon receiving this request, the system automatically generates a database schema for storing instances of the “Events” entity based on the provided schema definition. It also generates an API for accessing and manipulating the event instances.

The system then automatically provisions a database specifically for storing the instances of the “Events” entity, ensuring that the necessary storage infrastructure is set up and ready to handle event data. Finally, the generated API is deployed, making it available for use by other parts of the application.

With the API in place, developers can easily interact with the “Events” entity using high-level API calls, such as creating new events, retrieving event details, updating event information, and deleting events. The API handles the conversion between the API-level representation of the events and the storage-level representation, abstracting away the complexities of the underlying storage implementation.

By automating the generation of the database schema, API, and provisioning of the database, the method (700) significantly reduces the manual effort and time required to onboard the new “Events” entity. Developers can focus on utilizing the entity and building features around it rather than spending time on low-level implementation details.

### Creating a New Application Data Entity

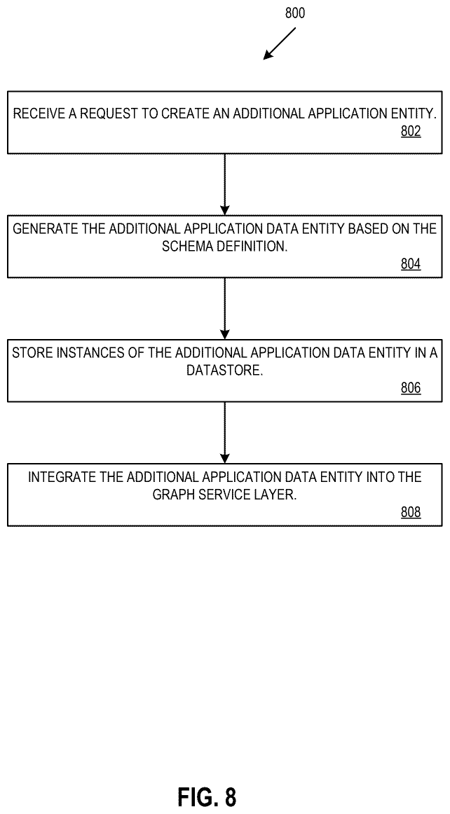

FIG. 8 illustrates a method (800) that focuses on the process of creating an additional application data entity and seamlessly integrating it into the graph serving layer. This approach addresses the challenges outlined above, which highlight the difficulties and time-consuming nature of integrating new entities and their relationships with existing entities in conventional systems.

As mentioned above, introducing additional application data entities in traditional systems often involves a complex process of defining the entity's schema, creating storage structures, and manually establishing relationships with existing entities. This process can be time-consuming and requires significant effort to ensure that the new entity is properly integrated and can be queried effectively within the context of the existing data model.

The method (800) these challenges by providing a streamlined approach to creating and integrating additional application data entities. When a request is received (802) to create a new entity, the request includes a schema definition that specifies the properties of the entity and its relationships with one or more existing entities. This schema definition provides a clear and structured way to define the entity's attributes and how it connects to the existing data model.

Based on the schema definition, the system, using one or more processors, generates (804) the additional application data entity. This generation process creates the necessary data structures and representations of the entity within the system. The instances of the new entity are then stored (806) in a datastore, providing a persistent storage mechanism for the entity's data.

An aspect of the method (800) is the integration (808) of the additional application data entity into the graph serving layer. This integration process involves two main steps. First, the structured vocabulary of the graph serving layer is updated to include the properties of the new entity and its relationships with existing entities. This update ensures that the graph serving layer has a comprehensive understanding of the new entity's structure and how it fits into the overall data model.

Second, the global look-aside index is updated to include entries for the instances of the new entity. These entries are linked to the entries of the related existing entities based on the relationships defined in the schema. By establishing these links in the index, the system enables efficient traversal and querying of the relationships between the new entity and the existing entities.

Once the additional application data entity is integrated into the graph serving layer, it becomes immediately queryable within the context of the existing entities. This means that queries can traverse the relationships between the new entity and the existing entities, allowing for seamless integration and efficient retrieval of connected data.

For example, consider an e-commerce application that currently has data entities for products, categories, and suppliers. The development team wants to introduce an additional data entity called “Reviews” to represent customer reviews for products.

The development team submits a request to create the “Reviews” entity, including a schema definition that specifies properties such as the review text, rating, author, and timestamp. The schema definition also includes a relationship between the “Reviews” entity and the existing “Products” entity, indicating that each review is associated with a specific product.

Based on the schema definition, the system generates the “Reviews” entity and stores instances of the entity in the datastore. The integration process begins by updating the structured vocabulary of the graph serving layer to include the properties of the “Reviews” entity and its relationship with the “Products” entity. This update ensures that the graph serving layer recognizes the structure and connections of the new entity.

Next, the global look-aside index is updated to include entries for the instances of the “Reviews” entity. These entries are linked to the corresponding entries of the related “Products” entity based on the defined relationship. This linking enables efficient traversal and querying of the relationships between reviews and products.

With the integration complete, the “Reviews” entity becomes immediately queryable within the context of the existing entities. Queries can now traverse the relationship between reviews and products, allowing for operations such as retrieving all reviews for a specific product, filtering products based on their average review rating, or aggregating review data across multiple products.

### Receiving and Executing Complex Queries

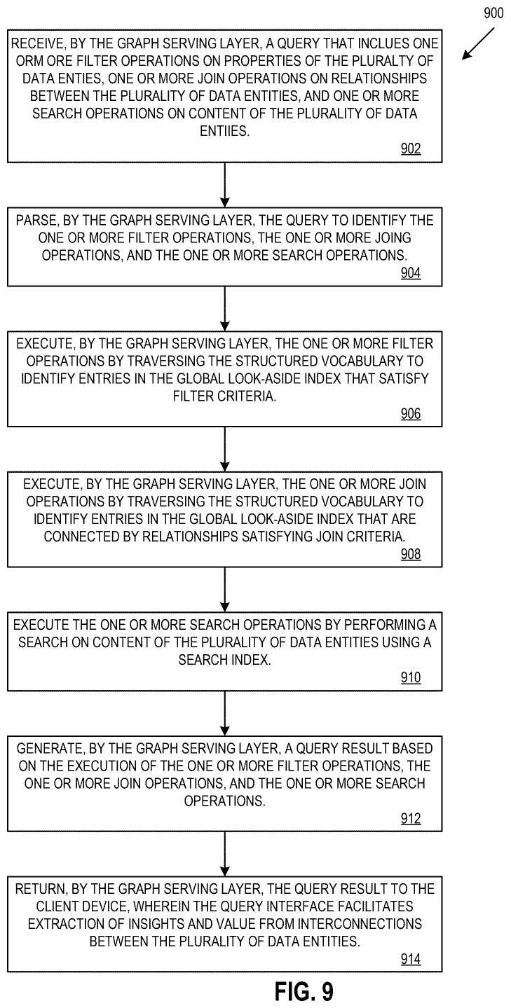

FIG. 9 illustrates a method (900) that focuses on the process of receiving and executing complex queries that involve filter operations, join operations, and search operations on the plurality of data entities. This approach addresses the challenges outlined above, which highlight the difficulties in performing efficient and insightful querying across interconnected entities in conventional systems.

As mentioned above, traditional systems often struggle with executing complex queries that require filtering, joining, and searching across multiple data entities. The siloed nature of data storage and the lack of efficient indexing mechanisms make it challenging to extract valuable insights and traverse the relationships between entities effectively.

The method (900) addresses these challenges by leveraging the graph serving layer and the global look-aside index introduced in FIG. 1. When a query is received (902) from a client device, it includes a combination of filter operations, join operations, and search operations on the properties, relationships, and content of the data entities.

The graph serving layer parses (904) the query to identify the specific operations requested. It then executes each type of operation using the structured vocabulary and the global look-aside index. For filter operations (906), the graph serving layer traverses the structured vocabulary to identify entries in the global look-aside index that satisfy the specified filter criteria. This allows for efficient filtering of entities based on their properties.

Similarly, for join operations (908), the graph serving layer traverses the structured vocabulary to identify entries in the global look-aside index that are connected by relationships satisfying the join criteria. This enables the system to efficiently navigate and combine data from multiple entities based on their relationships.

For search operations (910), the graph serving layer utilizes a search index to perform a search on the content of the data entities. This search index allows for efficient full-text searching and retrieval of entities based on their textual content.

After executing the filter, join, and search operations, the graph serving layer generates (912) a query result that combines the relevant data from the identified entities. This query result represents the outcome of the complex query, taking into account the specified criteria and the relationships between the entities.

Finally, the query result is returned (914) to the client device, providing the requested information in a structured and meaningful format. The query interface facilitated by the graph serving layer enables the extraction of insights and value from the interconnections between the data entities. By leveraging the relationships and properties captured in the structured vocabulary and the global look-aside index, the system can provide powerful querying capabilities that go beyond simple retrieval and allow for deep analysis and discovery of patterns within the data.

For example, consider a social media application that has data entities representing users, posts, comments, and likes. A client device submits a query to the graph serving layer with the following requirements:
Filter operations: Retrieve posts created by users within a specific age range (e.g., between 25 and 35 years old).
Join operations: Include the comments and likes associated with each retrieved post.
Search operations: Search for posts containing specific keywords (e.g., “travel” or “adventure”).

The graph serving layer parses the query and identifies the filter, join, and search operations. It starts by executing the filter operation, traversing the structured vocabulary to identify entries in the global look-aside index that represent posts created by users within the specified age range. This filtering process efficiently narrows down the relevant posts based on the user's age property.

Next, the graph serving layer executes the join operation, traversing the structured vocabulary to identify entries in the global look-aside index that are connected to the filtered posts through comment and like relationships. This join operation allows the system to retrieve the associated comments and likes for each post, providing a comprehensive view of the post's engagement.

Finally, the graph serving layer executes the search operation, performing a search on the content of the filtered posts using the search index. It identifies posts that contain the specified keywords, such as “travel” or “adventure,” further refining the query result.

The graph serving layer generates a query result that includes the filtered posts along with their associated comments, likes, and relevant keyword matches. This result is then returned to the client device, providing a rich and interconnected dataset that combines information from multiple entities based on the specified criteria.

### Evolving Existing Application Data Entities

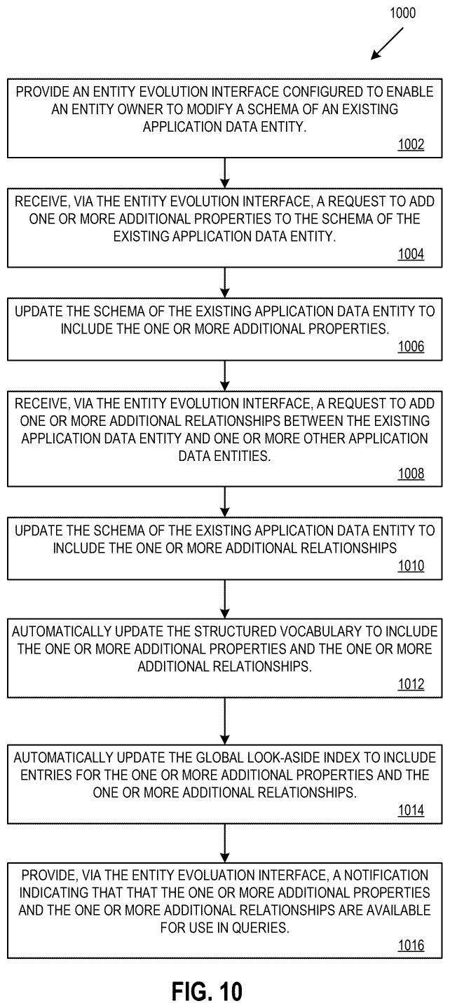

FIG. 10 illustrates a method (1000) that focuses on the process of evolving existing application data entities by modifying their schemas, adding additional properties and relationships, and automatically updating the structured vocabulary and global look-aside index. This approach addresses the challenges outlined above, which highlight the complexities and manual efforts required for entity evolution in conventional systems.

As mentioned above, traditional systems often struggle with the process of modifying and expanding existing data entities. Changing the schema of an entity, adding additional properties or relationships, and propagating those changes throughout the system can be a complex and time-consuming task. It often requires manual interventions, coordination across multiple teams, and significant effort to ensure consistency and availability of the updated entity for querying.

The method (1000) addresses these challenges by providing (1002) an entity evolution interface that enables entity owners to easily modify the schema of an existing application data entity. When an entity owner wants to add additional properties to the schema, they can submit a request through the entity evolution interface, specifying the desired changes.

Upon receiving (1004) the request, the system, using one or more processors, updates (1006) the schema of the existing application data entity to include the additional properties. This update expands the entity's definition to accommodate the additional attributes or fields.

Similarly, when an entity owner wants to add (1008) additional relationships between the existing entity and other application data entities, they can submit a request through the entity evolution interface. The system updates (1010) the schema of the existing entity to include the specified relationships, establishing new connections or associations with other entities.

An aspect of the method (1000) is the automatic updating (1012) of the structured vocabulary and the global look-aside index in response to the schema modifications. When additional properties or relationships are added to an entity's schema, the system automatically propagates those changes to the structured vocabulary. The vocabulary is updated to include the additional properties and relationships, ensuring that they are recognized and understood within the context of the graph serving layer.

Additionally, the global look-aside index is automatically updated to include entries for the additional properties and relationships. This update ensures that the index remains in sync with the modified entity schema and can efficiently handle queries involving the new attributes and connections.

Once the updates to the structured vocabulary and global look-aside index are complete, the system provides (1016) a notification through the entity evolution interface, indicating that the additional properties and relationships are available for use in queries. This notification informs entity owners and developers that the evolved entity is ready to be utilized and queried with the added functionality.

The automatic updating of the structured vocabulary and global look-aside index eliminates the need for manual updates and reduces the complexity and effort required for entity evolution compared to conventional approaches. By automating the propagation of schema changes, the system ensures consistency and immediate availability of the updated entity for querying, streamlining the entity evolution process.

For example, consider a customer relationship management (CRM) application that has an existing data entity called “Customer” with properties such as name, email, and phone number. The entity owner wants to evolve the “Customer” entity by adding a new property called “preferred_contact_method” and a new relationship with a “SalesRepresentative” entity.

Using the entity evolution interface, the entity owner submits a request to add the “preferred_contact_method” property to the “Customer” entity schema. The system updates the schema accordingly, including the new property in the entity's definition.

Next, the entity owner submits a request to add a relationship between the “Customer” entity and the “SalesRepresentative” entity, indicating that each customer can have an assigned sales representative. The system updates the schema of the “Customer” entity to include this new relationship.

After the schema modifications, the system automatically updates the structured vocabulary to include the “preferred_contact_method” property and the relationship with the “SalesRepresentative” entity. The vocabulary now recognizes and understands these new elements within the context of the graph serving layer.

Additionally, the global look-aside index is automatically updated to include entries for the new property and relationship. The index can now efficiently handle queries involving the preferred contact method and the association with sales representatives.

Finally, the system provides a notification through the entity evolution interface, indicating that the new property and relationship are available for use in queries. Entity owners and developers can now utilize the evolved “Customer” entity, querying based on the preferred contact method and accessing information about the assigned sales representatives.

### Managing Highly Relational Application Data

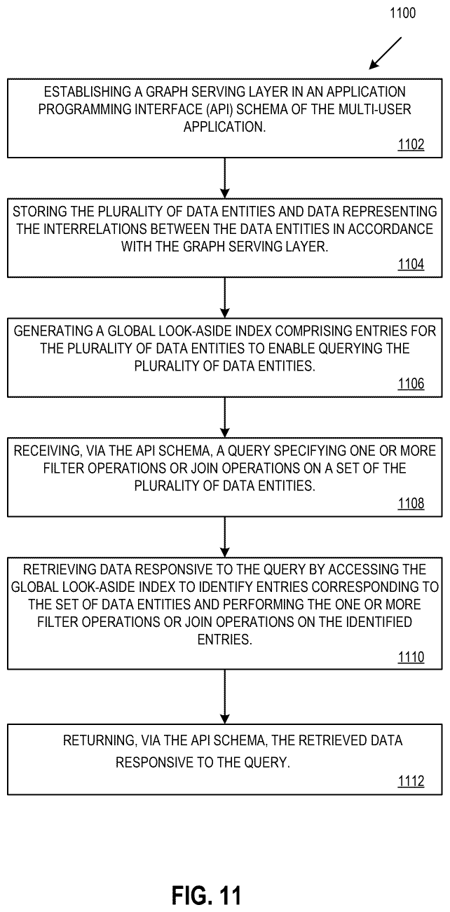

FIG. 11 illustrates a method (1100) for managing highly relational application data in a large-scale multi-user application (100). This method (1100) addresses the challenges outlined above, which highlights the difficulties in managing and querying interconnected data entities in a complex application environment. The following description of the method (1100) refers to FIG. 1.

The method (1100) begins by establishing (1102) a graph serving layer (106) within the application programming interface (API) schema (108) of the multi-user application (100). The graph serving layer (106) provides a structured vocabulary (110) that defines and describes the various data entities (114) and their interrelations (116) within the application. This structured vocabulary acts as a common language for representing and understanding the relationships between the entities, enabling efficient querying and manipulation of the data.

Once the graph serving layer (106) is established, the method involves storing (1104) the data entities (114) and their interrelations (116) in accordance with the defined structure. This storage process organizes the data in a way that aligns with the graph serving layer's vocabulary, ensuring consistency and accessibility of the entities and their relationships.

To enable efficient querying of the data entities (114), the method includes generating (1106) a global look-aside index (118). This index contains entries (120) corresponding to the data entities (114) and supports advanced querying operations such as filtering and joining. The global look-aside index acts as a secondary data structure that facilitates fast and targeted retrieval of entities based on specific criteria.

When a query is received (1108) via the API schema (108), specifying filter or join operations on a set of data entities (114), the method uses the global look-aside index (118) to retrieve (1110) the relevant data. The index is accessed to identify the entries corresponding to the queried entities, and the specified filter or join operations are performed on those entries. This targeted retrieval process leverages the efficiency of the global look-aside index, avoiding the need to scan through the entire dataset.

Finally, the method returns (1112) the retrieved data responsive to the query via the API schema (108). This allows the requesting application or user to access the desired information in a structured and efficient manner.

For example, consider a social media application that manages user profiles, posts, comments, and likes. The application has a large user base and a highly interconnected data model.

By establishing a graph serving layer (106) within the API schema (108), the application defines a structured vocabulary (110) that describes the entities such as user profiles, posts, comments, and likes, along with their interrelations. This vocabulary provides a clear and consistent way to represent and query the data.

The user profiles, posts, comments, and likes are stored (1104) in accordance with the graph serving layer's structure, ensuring that the relationships between these entities are properly captured and maintained.

To enable efficient querying, a global look-aside index (118) is generated (1106), containing entries (120) for the various data entities. This index allows for fast retrieval of specific user profiles, posts, comments, or likes based on different criteria.

When a query is received (1108), such as “find all posts liked by user X's friends,” the global look-aside index (118) is used to retrieve (1110) the relevant data. The index is accessed to identify the entries corresponding to user X's friends and their liked posts. The specified filter and join operations are performed on these entries to obtain the desired result set.

Finally, the retrieved data, containing the posts liked by user X's friends, is returned (1112) via the API schema (108), providing the requesting application or user with the requested information.

The method (1100) addresses the challenges outlined above by providing a structured approach to managing and querying highly relational data in a large-scale application. The graph serving layer (106) and the global look-aside index (118) work together to enable efficient storage, retrieval, and manipulation of interconnected entities, as highlighted above.

By leveraging the structured vocabulary (110) and the optimized querying capabilities of the global look-aside index (118), the method (1100) streamlines the process of accessing and analyzing complex data relationships, facilitating the development of feature-rich and performant applications, as emphasized above.

### Updating the Global Look-Aside Index Using a Change Capture Stream

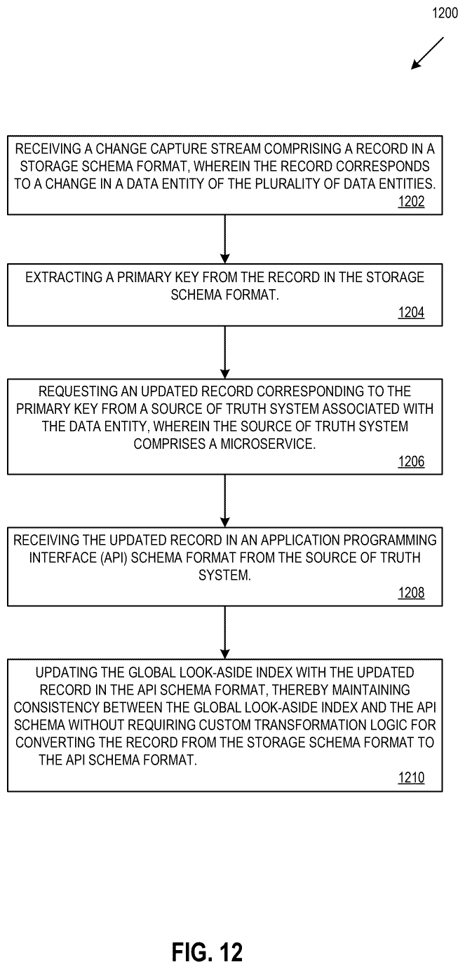

FIG. 12 focuses on the process (1200) of updating the global look-aside index (118) using a change capture stream. This approach addresses the challenge mentioned above regarding the conversion of records from the storage schema format to the API schema format, which is necessary for maintaining consistency between the index and the application's data model.

As discussed above, the provider of the large-scale multi-user application faces difficulties in managing highly relational data across siloed data entities. The creation of a global look-aside index (118) is part of an integrated architectural approach to streamline data querying and management. However, as highlighted above, building and maintaining this index poses a challenge when the change capture stream, which contains records in the storage schema format, needs to be converted to the API schema format used by the application.

The method (1200) addresses this challenge by leveraging the source of truth system (122) associated with each data entity (114). When a change capture stream is received (1202), containing a record in the storage schema format, the method (1200) extracts (1204) the primary key from the record. This primary key uniquely identifies the data entity (114) that has undergone a change.

Instead of attempting to transform the record from the storage schema format to the API schema format directly, the method (1200) makes a request (1206) to the source of truth system (122) associated with the data entity (114). In this case, the source of truth system (122) is a microservice (e.g., a REST microservice) responsible for managing the specific data entity (114). The method (1200) sends the primary key to the microservice, requesting the updated record corresponding to that key.

The microservice, upon receiving the request with the primary key, retrieves the updated record from its own data store and returns it to in the API schema format. This approach ensures that the global look-aside index (118) receives the record in the same format used by the application, maintaining consistency with the API schema (108).

Finally, the method (1200) updates (1210) the global look-aside index (118) with the received (1208) record in the API schema format. By leveraging the source of truth system (122) to perform the schema conversion, the method (1200) eliminates the need for custom transformation logic, which can be complex and difficult to maintain, as mentioned above.

Consider an example to illustrate the method (1200) where a multi-user application manages user profiles, posts, and comments. Each of these entities is managed by a separate microservice, which serves as the source of truth for its respective entity.

When a user updates their profile information, a change capture stream record is generated in the storage schema format, containing the updated fields and the user's primary key. The method (1200) receives this change capture stream record and extracts the primary key from it.

Instead of directly transforming the record from the storage schema format to the API schema format, the method (1200) sends a request to the user profile microservice, passing the extracted primary key. The microservice retrieves the updated user profile record from its data store and returns it to the method in the API schema format, which may include additional fields or a different structure compared to the storage schema format.

Upon receiving the updated record in the API schema format, the method (1200) updates the global look-aside index (118) with this record. This ensures that the index remains consistent with the application's data model and can efficiently serve queries related to user profiles.

By following this approach, the method (1200) simplifies the process of updating the global look-aside index (118) and maintains consistency with the API schema (108) without requiring complex transformation logic. This aligns with the goals outlined above, which aim to streamline data management and querying in the multi-user application.

The method (1200) contributes to the overall solution proposed above by providing an efficient and maintainable way to update the global look-aside index (118) using change capture streams. By leveraging the source of truth system (122) to convert records from the storage schema format to the API schema format, the method (1200) simplifies the index maintenance process and ensures consistency with the application's data model.

### Example Multi-User Application System

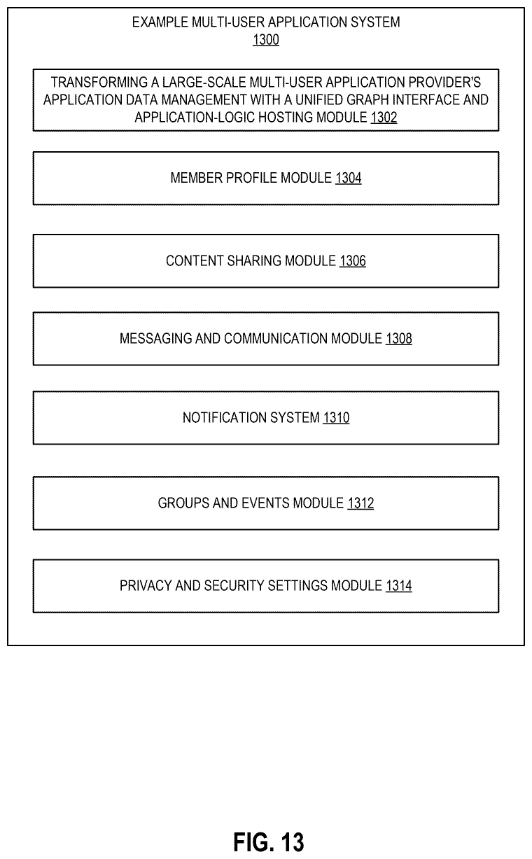

FIG. 13 illustrates an example multi-user application system 1300 in which the techniques disclosed herein for transforming a large-scale multi-user application provider's application data management with a unified graph interface and application-logic hosting are implemented. Example multi-user application system 1300 is implemented at least in part by one or more programmable electronic devices (e.g., example programmable electronic device 1400 of FIG. 1400) located or housed in one or more data centers or other physical computer hosting facilities. Example multi-user application system 1300 is connected to a data communications network, such as the internet, to interact with (e.g., exchange data with) the programmable electronic devices of users.

Example multi-user application system 1300 is an online service, platform, or site that focuses on facilitating the building of social, professional, organizational, community, or governmental networks or relations among people, business, organizations, governments, communities, groups, or other entities (generally “members”). Example multi-user application system 1300 allows members to connect with other members based on shared interests, backgrounds, real-life connections, or activities. Members create personal profiles where they post various types of content, such as text, photos, and videos, and engage with others through features like messaging, commenting, and liking.

Example multi-user application system 1300 offers a digital space for members to share their experiences, ideas, and thoughts, fostering communication and interaction across diverse communities. In an embodiment, example multi-user application system 1300 offers additional functionalities, such as creating groups, organizing events, and discovering content based on member preferences.

Example multi-user application system 1300 is composed of various modules and components, each serving a distinct function to enhance member experience and interaction. One module of example multi-user application system 1300 is the transforming a large-scale multi-user application provider's application data management with a unified graph interface and application-logic hosting module 1302 configured to perform or implement the techniques disclosed herein for transforming a large-scale multi-user application provider's application data management with a unified graph interface and application-logic hosting. In addition to transforming a large-scale multi-user application provider's application data management with a unified graph interface and application-logic hosting module 1302, example multi-user application system 1300 includes any or all of the following modules: member profile module 1304, content sharing module 1306, messaging and communication module 1308, notification system 1310, groups and events module 1312, privacy and security settings module 1314, or any other suitable multi-user application system module.

Member profile module 1304 allows members to create and manage their personal profiles, providing information about themselves and their interests. The member profile module 1304 provides a personal space for members to represent themselves and manage their presence on the platform. This member profile module 1304 allows members to create and customize their profiles, which act as their digital identity within the network. In an embodiment, the customization includes adding personal information such as name, profile picture, cover photo, logo, avatar, or a bio that reflects their identity, personality, or interests. In an embodiment, members also share additional details like their location, education, work history, and interests, helping to paint a more comprehensive picture of who they are.

Besides personal information, the member profile module 1304 enables members to showcase their activities and content on the platform. This includes a timeline or feed of their posts, photos, videos, and shared content, providing a chronological overview of their activity. Members manage the visibility of these elements, controlling who can see their posts and personal information through privacy settings integrated within the member profile module 1304.

Additionally, the member profile serves as a hub for social interactions. It allows others to view the member's information, connect by sending friend requests or follows, and engage with the member's content through likes, comments, and shares. In an embodiment, member profile module 1304 also includes features like badges or indicators of achievements and activities, further enriching the member's profile.

The content sharing module 1306 allows members to post, share, and interact with various types of content like text, images, and videos. This content sharing module 1306 provides the ability for members to upload different types of media, such as text posts, photos, videos, and links to external content. This content sharing module 1306 includes member-friendly interfaces for creating and editing posts, with, in an embodiment, tools for adding filters to photos, editing video clips, or formatting text. Once content is shared, it becomes visible to others within the member's network, depending on the member's privacy settings.

Content sharing module 1306 also facilitates interaction with this content, allowing viewers to like, comment, and share posts, thus promoting engagement and discussion. In an embodiment, advanced features include tagging other members, adding location data, or incorporating hashtags to categorize content and increase its visibility. Content sharing module 1306 integrates with the system 1300's algorithms to display content in members' feeds based on relevance, recency, and personal preferences. In an embodiment, module 1306 provided analytics to members, especially content creators or businesses, offering insights into the reach and engagement of their posts.

The messaging and communication module 1308 facilitates private and group conversations, enabling direct and instant communication among members. This messaging and communication module 1308 offers a range of functionalities that support both private and group messaging. For private messaging, members send and receive text messages, photos, videos, and links in a one-on-one setting, similar to a traditional Short Message Service (SMS) but with enhanced multimedia capabilities. In an embodiment, this private messaging supports features like read receipts, typing indicators, and the ability to send voice messages. In addition to private conversations, the messaging and communication module 1308 includes group messaging capabilities, allowing multiple members to communicate in a single thread. This is particularly useful for coordinating events, discussing common interests, or staying connected with a circle of friends or colleagues.

Additionally, the notification system 1310 keeps users informed about activities related to their profile, such as new follows, comments, or likes. The notification system 1310 keeps members informed and engaged with the platform's activities. This notification system 1310 functions by sending alerts to members about various interactions and updates related to their profile or content they are interested in. Notifications are triggered by a range of activities, such as when another member likes or comments on their posts, follows their profile, tags them in a photo, or mentions them in a comment. In an embodiment, notifications include alerts about messages received, event reminders, or updates from groups or pages the member follows.

The functionality of notification system 1310 is designed to be both informative and non-intrusive. Members can customize their notification settings, choosing what types of alerts they receive and how they are notified, whether through the platform's interface, email, or mobile push notifications. This customization enhances the member experience by allowing members to stay connected with the aspects of the platform they find most relevant, without being overwhelmed by excessive or irrelevant alerts.

In an embodiment, the notification system 1310 incorporates smart algorithms to prioritize and sometimes group notifications based on the member's past interactions and preferences. For instance, a member might receive a summarized notification of all the likes on a post instead of separate alerts for each like. This intelligent handling ensures that members are kept up to date with important interactions and events, helping to increase member engagement and encouraging them to interact more frequently with the platform.

For community building, the groups and events module 1312 allows the creation and management of interest-based groups and event organization. The groups and events module 1312 allows members to create, join, and interact within focused communities based on shared interests, causes, or activities. In an embodiment, these groups range from public, open to anyone, to private, where membership requires approval. Within a group, members post content, engage in discussions, share resources, and collaborate on projects or initiatives. Groups have their own set of rules and moderators to ensure a constructive and respectful environment. This feature is instrumental in connecting individuals with common interests and facilitating deeper, topic-centered interactions.

The events feature of the groups and events module 1312 complements the groups features of module 1312 by enabling members to create, share, and manage events. Members set up event pages, where they provide details such as date, time, location, and description. These pages become a hub for inviting attendees, sharing updates, and posting event-related content. The groups and events module 1312 includes tools for RSVPs, allowing both organizers and attendees to track who is planning to attend. In an embodiment, events are public or private, and are linked to specific groups or open to the broader network. This feature is particularly valuable for organizing meetups, workshops, conferences, or social gatherings, providing a seamless way to coordinate and communicate with participants.

Together, the groups and events module 1312 enhances the social aspect of the networking platform. It encourages members to engage in more meaningful, interest-based interactions and provides tools for organizing and participating in real-world events, thus bridging the gap between online connections and offline activities.

Lastly, the privacy and security settings module 1314 is designed to empower members with control over their personal information and interactions on the platform. This privacy and security settings module 1314 provides various settings and options that enable members to manage who can view their profile, content, and personal details, as well as who can contact them. Members adjust settings to make their profiles either more public or private, determining the visibility of posts, photos, and friend lists. In an embodiment, members choose to make their content visible to everyone, only to their friends, or to a custom list of specific individuals.

In addition to privacy controls, this privacy and security settings module 1314, in an embodiment, includes security features aimed at protecting members' accounts from unauthorized access. In an embodiment, this encompasses options like two-factor authentication, where a member must provide two forms of identification before accessing their account, and alerts for login attempts from unfamiliar devices or locations. In an embodiment, members also report suspicious activity and block or report other members who are harassing or spamming them.

Furthermore, the privacy and security settings module 1314 provides tools for members to manage how their data is collected and used by the platform. This includes settings for opting out of certain types of data collection or controlling how their information is used for advertising purposes. By offering these comprehensive privacy and security options, the privacy and security settings module 1314 not only safeguards members' personal information and accounts but also enhances their trust and comfort in using the platform, ultimately contributing to a safer and more controlled online environment.

### Example Programmable Electronic Device

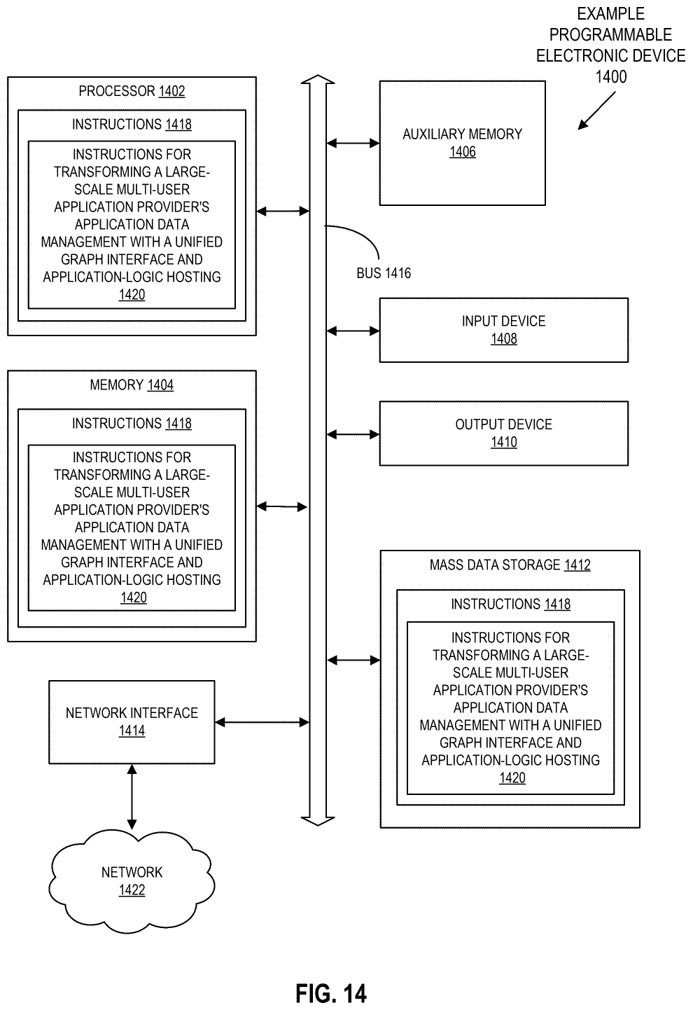

FIG. 14 illustrates an example of an example programmable electronic device that processes and manipulates data to perform the techniques disclosed herein for transforming a large-scale multi-user application provider's application data management with a unified graph interface and application-logic hosting. Example programmable electronic device 1400 includes electronic components encompassing hardware or hardware and software including processor 1402, memory 1404, auxiliary memory 1406, input device 1408, output device 1410, mass data storage 1412, and network interface 1414, all connected to bus 1416. Network 1422 is connected to, but not part of, example programmable electronic device 1400.

While only one of each type of component is depicted in FIG. 14 for the purpose of providing a clear example, multiple instances of any or all these electronic components, including possibly multiple different types of instances, are present in example programmable electronic device 1400 in other instances. For example, in an embodiment, multiple processors are connected to bus 1416 such as, for example, one or more Central Processing Units (CPUs) and one or more Graphics Processing Unit (GPU). Accordingly, unless the context clearly indicates otherwise, reference with respect to FIG. 14 to a component of example programmable electronic device 1400 in the singular such as, for example, processor 1402, is not intended to exclude the plural where, in a particular instance of example programmable electronic device 1400, multiple instances of the electronic component are present. Further, some electronic components might not be present in a particular instance of example programmable electronic device 1400. For example, example programmable electronic device 1400 in a headless configuration such as, for example, when operating as a server racked in a data center, might not include, or be connected to, input device 1408 or output device 1410.

Processor 1402 is an electronic component that processes (e.g., executes, interprets, or otherwise processes) instructions 1418 including instructions 1420 for transforming a large-scale multi-user application provider's application data management with a unified graph interface and application-logic hosting. In an embodiment, processor 1402 fetches, decodes, and executes instructions 1418 from memory 1404 and performs arithmetic and logic operations dictated by instructions 1418 and coordinates the activities of other electronic components of example programmable electronic device 1400 in accordance with instructions 1418. In an embodiment, processor 1402 is made using silicon wafers according to a manufacturing process (e.g., 14 nm, 10 nm, 7 nm, 5 nm, or 3 nm). In an embodiment, processor 1402 is configured to understand and execute a set of commands referred to as an instruction set architecture (ISA) (e.g., x86, x86_64, or ARM).

In an embodiment, processor 1402 includes a cache used to store frequently accessed instructions 1418 to speed up processing. In an embodiment, processor 1402 has multiple layers of cache (L1, L2, L3) with varying speeds and sizes.

In an embodiment, processor 1402 is composed of multiple cores where each such core is a processor within processor 1402. The cores allow processor 1402 to process multiple instructions 1418 at once in a parallel processing manner.

In an embodiment, processor 1402 supports multi-threading where each core of processor 1402 handles multiple threads (multiple sequences of instructions) at once to further enhance parallel processing capabilities.

In an embodiment, processor 1402 is any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other type of CPU suitable for the particular implementation at hand.

While processor 1402 might be a CPU, processor 1402, in an embodiment, is any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that is customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other type of processor suitable for the particular implementation at hand.

Memory 1404 is an electronic component that stores data and instructions 1418 that processor 1402 processes. In an embodiment, memory 1404 provides the space for the operating system, applications, and data in current use to be quickly reached by processor 1402. In an embodiment, memory 1404 is a random-access memory (RAM) that allows data items to be read or written in substantially the same amount of time irrespective of the physical location of the data items inside memory 1404.

In an embodiment, memory 1404 is a volatile or non-volatile memory. Data stored in a volatile memory is lost when the power is turned off. Data in non-volatile memory remains intact even when the system is turned off. In an embodiment, memory 1404 is Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. In an embodiment, memory 1404 is Static RAM (SRAM). SRAM is volatile memory that is typically faster but more expensive than DRAM. SRAM uses multiple transistors for each memory cell but does not need to be periodically refreshed. Additionally, or alternatively, SRAM is used for cache memory in processor 1402 in an embodiment. In an embodiment, memory 1404 encompasses both DRAM and SRAM.

Example programmable electronic device 1400 has auxiliary memory 1406 other than memory 1404. Examples of auxiliary memory 1406 include cache memory, register memory, read-only memory (ROM), secondary storage, virtual memory, memory controller, and graphics memory. In an embodiment, example programmable electronic device 1400 has multiple auxiliary memories including different types of auxiliary memories.

Cache memory is found inside or very close to processor 1402 and is typically faster but smaller than memory 1404. Cache memory is used to hold frequently accessed instructions 1418 (encompassing any associated data) to speed up processing. In an embodiment, cache memory is hierarchical ranging from Level 1 cache memory which is the smallest but fastest cache memory and is typically inside processor 1402 to Level 2 and Level 3 cache memory which are progressively larger and slower cache memories that are inside or outside processor 1402.

Register memory is a small but very fast storage location within processor 1402 designed to hold data temporarily for ongoing operations.

ROM is a non-volatile memory device that is only read, not written to. In an embodiment, ROM is a Programmable ROM (PROM), Erasable PROM (EPROM), or electrically erasable PROM (EEPROM). In an embodiment, ROM stores basic input/output system (BIOS) instructions which help example programmable electronic device 1400 boot up.

Secondary storage is a non-volatile memory. In an embodiment, secondary storage encompasses any or all of: a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device.

Virtual memory is a portion of a hard drive or an SSD that the operating system uses as if it were memory 1404. When memory 1404 gets filled, less frequently accessed data and instructions 1418 is “swapped” out to the virtual memory. The virtual memory is slower than memory 1404, but it provides the illusion of having a larger memory 1404.

A memory controller manages the flow of data and instructions 1418 to and from memory 1404. The memory controller is located either on the motherboard of example programmable electronic device 1400 or within processor 1402.

Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1408 is an electronic component that allows users to feed data and control signals into example programmable electronic device 1400. Input device 1408 translates a user's action or the data from the external world into a form that example programmable electronic device 1400 processes. Examples of input device 1408 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1410 is an electronic component that conveys information from example programmable electronic device 1400 to the user or to another device. The information is in the form of text, graphics, audio, video, or other media representation. Examples of output device 1410 include a monitor or display device, a printer device, a speaker device, a headphone device, a projector device, a plotter device, a braille display device, a haptic device, a LED or LCD panel device, a sound card, and a graphics or video card.

Mass data storage 1412 is an electronic component used to store data and instructions 1418. In an embodiment, mass data storage 1412 is non-volatile memory. Examples of mass data storage 1412 include a hard disk drive (HDD), a solid-state drive (SDD), an optical drive, a flash memory device, a magnetic tape drive, a floppy disk, an external drive, or a RAID array device.

In an embodiment, mass data storage 1412 is additionally or alternatively connected to example programmable electronic device 1400 via network 1422. In an embodiment, mass data storage 1412 encompasses a network attached storage (NAS) device, a storage area network (SAN) device, a cloud storage device, or a centralized network filesystem device.

Network interface 1414 (sometimes referred to as a network interface card, NIC, network adapter, or network interface controller) is an electronic component that connects example programmable electronic device 1400 to network 1422. Network interface 1414 functions to facilitate communication between example programmable electronic device 1400 and network 1422. Examples of a network interface 1414 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1416 is an electronic component that transfers data between other electronic components of or connected to example programmable electronic device 1400. Bus 1416 serves as a shared highway of communication for data and instructions (e.g., instructions 1418), providing a pathway for the exchange of information between components within example programmable electronic device 1400 or between example programmable electronic device 1400 and another device. Bus 1416 connects the different parts of example programmable electronic device 1400 to each other. In an embodiment, bus 1416 encompasses one or more of: a system bus, a front-side bus, a data bus, an address bus, a control bus, an expansion bus, a universal serial bus (USB), a I/O bus, a memory bus, an internal bus, an external bus, and a network bus.

Instructions 1418 are computer-processable instructions that take different forms. In an embodiment, instructions 1418 are in a low-level form such as binary instructions, assembly language, or machine code according to an instruction set (e.g., x86, ARM, MIPS) that processor 1402 is designed to process. In an embodiment, instructions 1418 include individual operations that processor 1402 is designed to perform such as arithmetic operations (e.g., add, subtract, multiply, divide, etc.); logical operations (e.g., AND, OR, NOT, XOR, etc.); data transfer operations including moving data from one location to another such as from memory 1404 into a register of processor 1402 or from a register to memory 1404; control instructions such as jumps, branches, calls, and returns; comparison operations; and specialization operations such as handling interrupts, floating-point arithmetic, and vector and matrix operations. In an embodiment, instructions 1418 are in a higher-level form such as programming language instructions in a high-level programming language such as Python, Java, C++, etc. In an embodiment, instructions 1418 are in an intermediate level form in between a higher-level form and a low-level form such as bytecode or an abstract syntax tree (AST).

Instructions 1418 for processing by processor 1402 are in different forms at the same or different times. In an embodiment, when stored in mass data storage 1412 or memory 1404, instructions 1418 are stored in a higher-level form such as Python, Java, or other high-level programing language instructions, in an intermediate-level form such as Python or Java bytecode that is compiled from the programming language instructions, or in a low-level form such as binary code or machine code. In an embodiment, when stored in processor 1402, instructions 1418 are stored in a low-level form such as binary instructions, assembly language, or machine code according to an instruction set architecture (ISA). In an embodiment, instructions 1418 are stored in processor 1402 in an intermediate level form or even a high-level form where CPU 1402 processes instructions in such form.

Instructions 1418 are processed by one or more processors of example programmable electronic device 1400 using a processing model such as any or all of the following processing models: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other processing model suitable to meet the requirements of the particular implementation at hand.

Network 1422 is a collection of interconnected computers, servers, and other programmable electronic devices that allow for the sharing of resources and information. Network 1422 ranges in size from just two connected devices to a global network (e.g., the internet) with many interconnected devices. In an embodiment, network 1422 encompasses network devices such as routers, switches, hubs, modems, and access points.

Individual devices on network 1422 are sometimes referred to as “network nodes.” Network nodes communicate with each other through mediums or channels sometimes referred to as “network communication links.” The network communication links are wired (e.g., twisted-pair cables, coaxial cables, or fiber-optic cables) or wireless (e.g., Wi-Fi, radio waves, or satellite links). Network nodes follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol).

Network 1422 has a particular physical or logical layout or arrangement sometimes referred to as a “network topology.” Example network topologies include bus, star, ring, and mesh. In an embodiment, network 1422 encompasses any or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

### Terminology

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses all of (a) a single processor configured to carry out recitations A, B, and C; (b) multiple processors where each processor is configured to carry out recitations A, B, and C; and (c) a first processor configured to carry out recitation A working in conjunction (e.g., as a team) with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses all of: (a) a single server configured to carry out recitations A, B, and C; (b) multiple servers each configured to carry out recitations A, B, and C; and (c) a first server configured to carry out recitations A and B working in conjunction (e.g., as a team) with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### Privacy

In an embodiment, the techniques described herein are implemented with privacy safeguards to protect user privacy. Furthermore, in an embodiment, the techniques described herein are implemented with user privacy safeguards to prevent unauthorized access to personal data and confidential data. The training of the artificial intelligence (“AI”) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, in an embodiment, users have full control over the visibility of their content and who sees their content, as is controlled via the visibility settings. According to the techniques described herein, in an embodiment, users have full control over the level of their personal data that is shared and distributed between different AI platforms that provide different functionalities. According to the techniques described herein, in an embodiment, users have full control over the level of access to their personal data that is shared with other parties. According to the techniques described herein, personal data provided by users is, in an embodiment, processed to determine prompts when using a generative AI feature at the request of the user, but not to train generative AI models. In an embodiment, users provide feedback while using the techniques described herein, which are used to improve or modify the platform and products. In an embodiment, any personal data associated with a user, such as personal information provided by the user to the platform, is deleted from storage upon user request. In an embodiment, personal information associated with a user is permanently deleted from storage when a user deletes their account from the platform.

According to the techniques described herein, personal data is, in an embodiment, removed from any training dataset that is used to train AI models. The techniques described herein, in an embodiment, utilize tools for anonymizing member and customer data. For example, user's personal data is, in an embodiment, redacted and minimized in training datasets for training AI models through delexicalization tools and other privacy enhancing tools for safeguarding user data. The techniques described herein, in an embodiment, minimize use of any personal data in training AI models, including removing and replacing personal data. According to the techniques described herein, notices are, in an embodiment, communicated to users to inform how their data is being used and users are provided controls to opt-out from their data being used for training AI models.

According to some embodiments, tools are used with the techniques described herein to identify and mitigate risks associated with AI in all products and AI systems. In an embodiment, notices are provided to users when AI tools are being used to provide features.

What is claimed is:

1. A method for managing highly relational application data in a large-scale multi-user application, the method comprising:
establishing, by one or more processors, a graph serving layer in an application programming interface (API) schema of the multi-user application, wherein the graph serving layer provides a structured vocabulary for describing a plurality of data entities and interrelations between the plurality of data entities within the multi-user application;
storing, by the one or more processors, the plurality of data entities and data representing the interrelations between the data entities in accordance with the graph serving layer;
generating, by the one or more processors, a global look-aside index comprising entries for the plurality of data entities to enable querying the plurality of data entities, wherein the global look-aside index supports filter operations and join operations over the entries for the plurality of data entities;
receiving, by the one or more processors via the API schema, a query specifying one or more filter operations or join operations on a set of the plurality of data entities;
retrieving, by the one or more processors, data responsive to the query by accessing the global look-aside index to identify entries corresponding to the set of data entities and performing the one or more filter operations or join operations on the identified entries; and
returning, by the one or more processors via the API schema, the retrieved data responsive to the query.

2. The method of claim 1, further comprising:
providing, by the one or more processors, a managed online service component configured to host application logic for one or more additional data entities, wherein the managed online service component is integrated with the graph serving layer;
receiving, by the one or more processors via the managed online service component, a request to create an additional data entity, wherein the request specifies a data definition for the additional data entity and one or more relationships between the additional data entity and one or more of the plurality of data entities;
creating, by the one or more processors, the additional data entity based on the data definition;
storing, by the one or more processors in accordance with the graph serving layer, the additional data entity and data representing the one or more relationships between the additional data entity and the one or more of the plurality of data entities;
updating, by the one or more processors, the global look-aside index to include one or more entries corresponding to the additional data entity to enable querying the additional data entity in conjunction with the plurality of data entities; and
hosting, by the one or more processors in the managed online service component, application logic for filtering a collection of data entities including the additional data entity based on one or more rulesets.

3. The method of claim 1, further comprising:
aggregating, by the global look-aside index, data records and relationships from the plurality of data entities across the large-scale multi-user application to overcome limitations of siloed datasets while maintaining microservice-based isolation and encapsulation of the plurality of data entities;
providing, by the global-look-aside index, real-time online querying capabilities for immediate access and manipulation of data from the plurality of data entities;
operating, by the global-look aside index, as a look-aside service in parallel with and without intruding on primary data storage or operations of source-of-truth datastores maintaining the plurality of data entities; and
facilitating, by the global-look aside index, efficient look-ups by non-primary keys, attribute filters, and edge traversals.

4. The method of claim 1, further comprising:
maintaining, by the graph serving layer, application logic for querying and manipulating the plurality of data entities within respective microservices hosting the plurality of data entities;
executing, by the global look-aside index, queries over the plurality of data entities without relocating or duplicating the application logic maintained within the respective microservices.

5. The method of claim 1, further comprising:
operating, by the global look-aside index, at an application-level schema abstraction, rather than at a storage-level schema abstraction;
maintaining, by the global look-aside index, consistency with the graph serving layer by working alongside existing application-level schemas; and
executing, by the global look-aside index, join operations over the entries for the plurality of data entities at a global look-aside index.

6. The method of claim 1, further comprising:
providing, by the one or more processors, an entity definition interface configured to enable an entity owner to define a schema and behaviors for an additional application data entity as code;
receiving, by the one or more processors via the entity definition interface, an entity definition for the additional application data entity;
generating, by the one or more processors, the additional application data entity based on the entity definition; and
integrating, by the one or more processors, the additional application data entity into the graph serving layer within a predetermined threshold amount of time of receiving the entity definition, thereby reducing a time period from conception to production for the additional application data entity.

7. The method of claim 1, further comprising:
receiving, by the one or more processors, a request to create an additional application data entity, wherein the request includes a schema definition for the additional application data entity;
automatically generating, by the one or more processors based on the schema definition, a database schema for storing instances of the additional application data entity and an application programming interface (API) for accessing the instances of the additional application data entity;
provisioning, by the one or more processors, a database for storing the instances of the additional application data entity based on the database schema; and
deploying, by the one or more processors, the API for accessing the instances of the additional application data entity, wherein the API includes functionality for converting between an API-level representation of the instances and a storage-level representation of the instances.

8. The method of claim 1, further comprising:
receiving, by the one or more processors, a request to create an additional application data entity, wherein the request includes a schema definition specifying one or more properties of the additional application data entity and one or more relationships between the additional application data entity and one or more existing application data entities;
generating, by the one or more processors, the additional application data entity based on the schema definition;
storing, by the one or more processors, instances of the additional application data entity in a datastore;
integrating, by the one or more processors, the additional application data entity into the graph serving layer by:
updating the structured vocabulary to include the one or more properties of the additional application data entity and the one or more relationships between the additional application data entity and the one or more existing application data entities; and
updating the global look-aside index to include entries for the instances of the additional application data entity, wherein the entries are linked to entries for instances of the one or more existing application data entities based on the one or more relationships; and
executing, by the one or more processors, a query that traverses the one or more relationships between the additional application data entity and the one or more existing application data entities, wherein integrating the additional application data entity into the graph serving layer enables the additional application data entity to be queryable within a context of the one or more existing application data entities.

9. The method of claim 1, further comprising:
receiving, by the graph serving layer from a client device, a query that includes one or more filter operations on properties of the plurality of data entities, one or more join operations on relationships between the plurality of data entities, and one or more search operations on content of the plurality of data entities;
parsing, by the graph serving layer, the query to identify the one or more filter operations, the one or more join operations, and the one or more search operations;
executing, by the graph serving layer, the one or more filter operations by traversing the structured vocabulary to identify entries in the global look-aside index that satisfy filter criteria;
executing, by the graph serving layer, the one or more join operations by traversing the structured vocabulary to identify entries in the global look-aside index that are connected by relationships satisfying join criteria;
execute the one or more search operations by performing a search on content of the plurality of data entities using a search index;
generating, by the graph serving layer, a query result based on the execution of the one or more filter operations, the one or more join operations, and the one or more search operations; and
returning, by the graph serving layer, the query result to the client device, wherein the query interface facilitates extraction of insights and value from interconnections between the plurality of data entities.

10. The method of claim 1, further comprising:
providing, by the one or more processors, an entity evolution interface configured to enable an entity owner to modify a schema of an existing application data entity;
receiving, by the one or more processors via the entity evolution interface, a request to add one or more additional properties to the schema of the existing application data entity;
updating, by the one or more processors, the schema of the existing application data entity to include the one or more additional properties;
receiving, by the one or more processors via the entity evolution interface, a request to add one or more additional relationships between the existing application data entity and one or more other application data entities;
updating, by the one or more processors, the schema of the existing application data entity to include the one or more additional relationships;
automatically updating, by the one or more processors, the structured vocabulary to include the one or more additional properties and the one or more additional relationships;
automatically updating, by the one or more processors, the global look-aside index to include entries for the one or more additional properties and the one or more additional relationships; and providing, by the one or more processors via the entity evolution interface, a notification indicating that the one or more additional properties and the one or more additional relationships are available for use in queries.

11. The method of claim 1, further comprising:
receiving, by the one or more processors, a change capture stream comprising a record in a storage schema format, wherein the record corresponds to a change in a data entity of the plurality of data entities;
extracting, by the one or more processors, a primary key from the record in the storage schema format;
requesting, by the one or more processors, an updated record corresponding to the primary key from a source of truth system associated with the data entity, wherein the source of truth system comprises a microservice;
receiving, by the one or more processors, the updated record in an application programming interface (API) schema format from the source of truth system; and
updating, by the one or more processors, the global look-aside index with the updated record in the API schema format, thereby maintaining consistency between the global look-aside index and the API schema without requiring custom transformation logic for converting the record from the storage schema format to the API schema format.

12. A system comprising:
at least one processor;
memory; and
instructions stored in the memory to be executed by the at least one processor for:
establishing, by one or more processors, a graph serving layer in an application programming interface schema of the multi-user application, wherein the graph serving layer provides a structured vocabulary for describing a plurality of data entities and interrelations between the plurality of data entities within the multi-user application;
storing, by the one or more processors, the plurality of data entities and data representing the interrelations between the data entities in accordance with the graph serving layer;
generating, by the one or more processors, a global look-aside index comprising entries for the plurality of data entities to enable querying the plurality of data entities, wherein the global look-aside index supports filter operations and join operations over the entries for the plurality of data entities;
receiving, by the one or more processors via the API schema, a query specifying one or more filter operations or join operations on a set of the plurality of data entities;
retrieving, by the one or more processors, data responsive to the query by accessing the global look-aside index to identify entries corresponding to the set of data entities and performing the one or more filter operations or join operations on the identified entries; and
returning, by the one or more processors via the API schema, the retrieved data responsive to the query.

13. The system of claim 12, instructions stored in the memory to be executed by the at least one processor further comprising instructions to be executed by the at least one processor for:
providing, by the one or more processors, a managed online service component configured to host application logic for one or more additional data entities, wherein the managed online service component is integrated with the graph serving layer;
receiving, by the one or more processors via the managed online service component, a request to create an additional data entity, wherein the request specifies a data definition for the additional data entity and one or more relationships between the additional data entity and one or more of the plurality of data entities;
creating, by the one or more processors, the additional data entity based on the data definition;
storing, by the one or more processors in accordance with the graph serving layer, the additional data entity and data representing the one or more relationships between the additional data entity and the one or more of the plurality of data entities;
updating, by the one or more processors, the global look-aside index to include one or more entries corresponding to the additional data entity to enable querying the additional data entity in conjunction with the plurality of data entities; and
hosting, by the one or more processors in the managed online service component, application logic for filtering a collection of data entities including the additional data entity based on one or more rulesets.

14. The system of claim 12, instructions stored in the memory to be executed by the at least one processor further comprising instructions to be executed by the at least one processor for:
aggregating, by the global look-aside index, data records and relationships from the plurality of data entities across the large-scale multi-user application to overcome limitations of siloed datasets while maintaining microservice-based isolation and encapsulation of the plurality of data entities;
providing, by the global-look-aside index, real-time online querying capabilities for immediate access and manipulation of data from the plurality of data entities;
operating, by the global-look aside index, as a look-aside service in parallel with and without intruding on primary data storage or operations of source-of-truth datastores maintaining the plurality of data entities; and
facilitating, by the global-look aside index, efficient look-ups by non-primary keys, attribute filters, and edge traversals.

15. The system of claim 12, instructions stored in the memory to be executed by the at least one processor further comprising instructions to be executed by the at least one processor for:
maintaining, by the graph serving layer, application logic for querying and manipulating the plurality of data entities within respective microservices hosting the plurality of data entities;
executing, by the global look-aside index, queries over the plurality of data entities without relocating or duplicating the application logic maintained within the respective microservices.

16. The system of claim 12, instructions stored in the memory to be executed by the at least one processor further comprising instructions to be executed by the at least one processor for:
operating, by the global look-aside index, at an application-level schema abstraction, rather than at a storage-level schema abstraction;
maintaining, by the global look-aside index, consistency with the graph serving layer by working alongside existing application-level schemas; and
executing, by the global look-aside index, join operations over the entries for the plurality of data entities at a global look-aside index.

17. A non-transitory computer-readable medium storing instructions which, when executed by at least one programmable electronic device, cause the at least one programmable electronic device to perform operations comprising:
establishing, by one or more processors, a graph serving layer in an application programming interface schema of the multi-user application, wherein the graph serving layer provides a structured vocabulary for describing a plurality of data entities and interrelations between the plurality of data entities within the multi-user application;
storing, by the one or more processors, the plurality of data entities and data representing the interrelations between the data entities in accordance with the graph serving layer;
generating, by the one or more processors, a global look-aside index comprising entries for the plurality of data entities to enable querying the plurality of data entities, wherein the global look-aside index supports filter operations and join operations over the entries for the plurality of data entities;
receiving, by the one or more processors via the API schema, a query specifying one or more filter operations or join operations on a set of the plurality of data entities;
retrieving, by the one or more processors, data responsive to the query by accessing the global look-aside index to identify entries corresponding to the set of data entities and performing the one or more filter operations or join operations on the identified entries; and
returning, by the one or more processors via the API schema, the retrieved data responsive to the query.

18. The non-transitory computer-readable medium of claim 16, further comprising instructions which, when executed by at least one programmable electronic device, cause the at least one programmable electronic device to perform operations comprising:
providing, by the one or more processors, a managed online service component configured to host application logic for one or more additional data entities, wherein the managed online service component is integrated with the graph serving layer;
receiving, by the one or more processors via the managed online service component, a request to create an additional data entity, wherein the request specifies a data definition for the additional data entity and one or more relationships between the additional data entity and one or more of the plurality of data entities;
creating, by the one or more processors, the additional data entity based on the data definition;
storing, by the one or more processors in accordance with the graph serving layer, the additional data entity and data representing the one or more relationships between the additional data entity and the one or more of the plurality of data entities;
updating, by the one or more processors, the global look-aside index to include one or more entries corresponding to the additional data entity to enable querying the additional data entity in conjunction with the plurality of data entities; and
hosting, by the one or more processors in the managed online service component, application logic for filtering a collection of data entities including the additional data entity based on one or more rulesets.

19. The non-transitory computer-readable medium of claim 16, further comprising instructions which, when executed by at least one programmable electronic device, cause the at least one programmable electronic device to perform operations comprising:
aggregating, by the global look-aside index, data records and relationships from the plurality of data entities across the large-scale multi-user application to overcome limitations of siloed datasets while maintaining microservice-based isolation and encapsulation of the plurality of data entities;
providing, by the global-look-aside index, real-time online querying capabilities for immediate access and manipulation of data from the plurality of data entities;
operating, by the global-look aside index, as a look-aside service in parallel with and without intruding on primary data storage or operations of source-of-truth datastores maintaining the plurality of data entities; and
facilitating, by the global-look aside index, efficient lookups by non-primary keys, attribute filters, and edge traversals.

20. The non-transitory computer-readable medium of claim 16, further comprising instructions which, when executed by at least one programmable electronic device, cause the at least one programmable electronic device to perform operations comprising:
maintaining, by the graph serving layer, application logic for querying and manipulating the plurality of data entities within respective microservices hosting the plurality of data entities;
executing, by the global look-aside index, queries over the plurality of data entities without relocating or duplicating the application logic maintained within the respective microservices.
